(19) United States
(12) Patent Application Publication
(10) Pub. No.: US 2007/0300288 A1
(43) Pub. Date: Dec. 27, 2007

(54) COMPUTER DISPLAY MONITORING APPARATUS, SYSTEM INCLUDING THE SAME, AND COMPUTER DISPLAY MONITORING METHOD

(75) Inventor: In Chul Choi, Seongnam (KR)

Correspondence Address: RABIN & Berdo, PC, 1101 14TH STREET, NW, SUITE 500, WASHINGTON, DC, 20005, US

(73) Assignee: ADVANCED DIGITAL CHIPS INC., Seoul (KR)

(21) Appl. No.: 11/531,038

(22) Filed: Sep. 12, 2006

(30) Foreign Application Priority Data
Jun. 27, 2006 (KR) 10-2006-0058311

(51) Int. Cl. H04L 9/32; G08B 21/00; G08B 23/00

(52) U.S. Cl. 726/2; 726/27; 340/540; 340/573.1

(57) ABSTRACT

Disclosed are a computer display monitoring apparatus, a system including the same, and a computer display monitoring method. The computer display monitoring system includes a computer terminal; a monitor; and a display monitoring apparatus provided between the computer terminal and the monitor for capturing a video signal transmitted from the computer terminal to the monitor, the display monitoring apparatus including a first coupler and a second coupler. The display monitoring apparatus receives a control signal from the computer terminal through universal serial bus (USB) communication and controls a physical coupling/decoupling between the first coupler and the computer terminal and between the second coupler and the monitor according to the received control signal, the computer terminal generates the control signal to control the display monitoring apparatus, transmits the generated control signal to the display monitoring apparatus through the USB communication, and transmits the video signal to the display monitoring apparatus via the first coupler, and the monitor receives the video signal from the display monitoring apparatus via the second coupler.

### BACKGROUND OF THE INVENTION

1. Field of the Invention

The present invention relates to a computer display monitoring apparatus, a system including the same, and a computer display monitoring method, and more particularly, to a computer display monitoring apparatus, which is provided between a computer and a monitor in such a manner that a coupling between the computer and the monitor can not be released at random, for capturing, storing and reproducing a video signal outputted from the computer, a system including the same, and a computer display monitoring method.

2. Description of the Related Art

Internet has have a tremendous effect on our life, and with rapid development of information and telecommunication technology, many efforts have been made to provide various kinds of useful information for us at a higher speed and with a higher precision. The Internet, being a reservoir of information, has an enormous number of cyber spaces, being called “web site,” in which numerous kinds of materials are contained. Spread of information through the Internet has been accelerated with development of various kinds of communication networks.

However, although the fast-growing Internet allows us to acquire a large amount of information with ease, it also may contain various kinds of harmful information and thus have an adverse effect on users who are defenselessly exposed to the Internet. Especially, impressionable young boys and girls may acquire harmful information without restrictions through CDs(Compact Discs), DVDs (Digital Versatile Discs) and so on as well as the Internet in home, schools, educational institutes, etc.

Moreover, as anyone may access the Internet without difficulty, harmful side effects may be produced. For example, some office workers may spend much time on nonoccupational affairs, such as stock trading and the like, at work, thus lowering work efficiency, or computer users may be addicted to computer entertainment or games so badly as to be hindered in their daily life.

To overcome this problem, there has been conventionally proposed a method of restricting use of a computer by means of a magnetic card or an IC card. However, this method has a demerit in that information used by a computer user is unknown.

As an alternative, there has been another method of installing and controlling a harmful information blocking program in a computer. However, this method has problems in that it is not easy for a person who is unfamiliar with a computer to install and control the program and the installed program can be removed from the computer because of software characteristics.

As another alternative, Korean Utility Model Registration No. 20-176989 and Korean Utility Model publication No. 1999-21594 disclose a monitoring system or apparatus for monitoring a screen of a computer on which a picture is displayed. However, only a connector connecting the computer to the monitoring system is described in Korean Utility Model Registration No. 20-176989 and a coupler between the computer and the monitoring apparatus is not described at all in Korean Utility Model publication No. 1999-21594. Therefore, although the conventional monitoring system or apparatus can monitor the screen of the computer on which a picture is displayed, there is a problem in that a computer user may release a coupling between the computer and the monitoring system or apparatus at random, which may result in decrease of monitoring efficiency.

### SUMMARY OF THE INVENTION

In order to overcome the above problems, it is an object of the present invention to provide a computer display monitoring apparatus, which is provided between a computer and a monitor, for capturing, storing and reproducing a video signal outputted from the computer, a system including the same, and a computer display monitoring method.

It is another object of the present invention to provide a computer display monitoring apparatus which is provided between a computer and a monitor and includes couplers mechanically actuating based on an electrical control signal in such a manner that a coupling between the computer and the monitor can not be released at random, a system including the same, and a computer display monitoring method.

To achieve the above objects, according to a first aspect of the present invention, there is provided a display monitoring system including a computer terminal; a monitor; and a display monitoring apparatus provided between the computer terminal and the monitor for capturing a video signal transmitted from the computer terminal to the monitor, the display monitoring apparatus including a first coupler and a second coupler. The display monitoring apparatus receives a control signal from the computer terminal through universal serial bus (USB) communication and controls a physical coupling/decoupling between the first coupler and the computer terminal and between the second coupler and the monitor according to the received control signal, the computer terminal generates the control signal to control the display monitoring apparatus, transmits the generated control signal to the display monitoring apparatus through the USB communication, and transmits the video signal to the display monitoring apparatus via the first coupler, and the monitor receives the video signal from the display monitoring apparatus via the second coupler.

Preferably, when the display monitoring apparatus is coupled to the computer terminal through the first coupler, a display monitoring apparatus control program stored in the display monitoring apparatus is automatically installed into the computer terminal through the USB communication.

Preferably, the computer terminal includes a remote access server for receiving a control signal to remotely control the display monitoring apparatus from a remote computer.

Preferably, the computer terminal includes a mobile access agent for receiving a control signal to remotely control the display monitoring apparatus from a mobile terminal.

Preferably, at least one of the first and second couplers includes a connector base forming an external appearance of the at least one coupler; a pair of screw shafts being located in both sides of the connector base, each screw shaft having one end portion coupled to the computer terminal or the monitor and the other end portion being formed with a slot for rotation; a connector port being located in one end portion of the connector base in a connection direction of the computer terminal or the monitor and including a connecting terminal formed in a portion connected to the computer terminal or the monitor; a connector cable being located in the other end portion of the connector base in a direction opposite to the connection direction of the computer terminal or the monitor for transmitting an analog video signal inputted/outputted to the computer terminal or the monitor or a control signal inputted from a controller; a motor being located in the connector base and rotating according to the control signal inputted from the controller; a rack being located in a direction from the motor to the connector cable and having a pair of holes formed in both sides of the rack, the rack being interlocked with the motor, the pair of holes being aligned with the slots of the pair of screw shafts to expose the slots of the pair of screw shafts or to prevent the slots of the pair of screw shafts from being exposed; and a connector cover being combined with the connector base to form an external appearance of the at least one coupler.

Preferably, the at least one coupler further includes a gear located between the motor and the rack and interlocked with the motor to actuate the rack.

Preferably, at least one of the first and second couplers includes a connector base forming an external appearance of the at least one coupler; a pair of screw shafts being located in both sides of the connector base, each screw shaft having one end portion coupled to the computer terminal or the monitor and the other end portion being formed with rotating means; a connector port being located in one end portion of the connector base in a connection direction of the computer terminal or the monitor and including a connecting terminal formed in a portion connected to the computer terminal or the monitor; a connector cable being located in the other end portion of the connector base in a direction opposite to the connection direction of the computer terminal or the monitor for transmitting an analog video signal inputted/outputted to the computer terminal or the monitor or a control signal inputted from a controller; a motor being located in the connector base and rotating according to the control signal inputted from the controller; a rack being located in a direction from the motor to the connector cable and having a pair of holes formed in both sides of the rack, the rack being interlocked with the motor so that the screw shafts inserted in the pair of holes can be rotated or not; and a connector cover being combined with the connector base to form an external appearance of the at least one coupler.

Preferably, the screw shafts are formed with slots in rotational axes of the rotating means and each of the holes of the rack has two integrated portions having different diameters, and the slots of the screw shafts are located in a portion having a larger diameter in each of the holes of the rack so that the screw shafts can be rotated at the time of decoupling, and the slots of the screw shafts are located in a portion having a smaller diameter in each of the holes of the rack so that the screw shafts can not be rotated at the time of coupling.

Preferably, the at least one coupler further includes a gear located between the motor and the rack and interlocked with the motor to actuate the rack.

Preferably, at least one of the first and second couplers includes a solenoid to control coupling/decoupling to/from the computer terminal or the monitor, and is coupled to and physically locked in the computer terminal or the monitor.

According to a second aspect of the present invention, there is provided a computer display monitoring apparatus including a first coupler coupled to and physically locked in a video card of a computer for transmitting an analog video signal outputted from the video card; an A/D (analog-to-digital) converter for converting the analog video signal inputted from the first coupler into a digital video signal; a signal processing and storing unit for compressing and storing the digital video signal from the A/D converter at a preset time interval, and decompressing the compressed and stored digital video signal; a D/A (digital-to-analog) converter for converting the decompressed digital video signal outputted from the signal processing and storing unit into an analog video signal; a switch for optionally transmitting the analog video signal inputted from the video card and the analog video signal inputted from the D/A converter to the monitor; a second coupler coupled to and physically locked in the monitor for transmitting the analog video signal inputted from the switch to the monitor; and a controller for controlling the signal processing and storing unit, controlling the physical locking between the first coupler and the video card, and controlling the physical locking between the second coupler and the monitor.

Preferably, the computer display monitoring apparatus further includes an extensible connecting cable connecting at least one of the first and second couplers to a connecting part located in the computer display monitoring apparatus.

Preferably, the computer display monitoring apparatus further includes an input unit receiving access data or a control signal from the outside.

Preferably, at least one of the first and second couplers includes a connector base forming an external appearance of the at least one coupler; a pair of screw shafts being located in both sides of the connector base, each screw shaft having one end portion coupled to the video card or the monitor and the other end portion being formed with a slot for rotation; a connector port being located in one end portion of the connector base in a connection direction of the video card or the monitor and including a connecting terminal formed in a portion connected to the video card or the monitor; a connector cable being located in the other end portion of the connector base in a direction opposite to the connection direction of the video card or the monitor for transmitting an analog video signal inputted/outputted to the video card or the monitor or a control signal inputted from a controller; a motor being located in the connector base and rotating according to the control signal inputted from the controller; a rack being located in a direction from the motor to the connector cable and having a pair of holes formed in both sides of the rack, the rack being interlocked with the motor, the pair of holes being aligned with the slots of the pair of screw shafts to expose the slots of the pair of screw shafts or to prevent the slots of the pair of screw shafts from being exposed; and a connector cover being combined with the connector base to form an external appearance of the at least one coupler.

Preferably, the at least one coupler further includes a gear located between the motor and the rack and interlocked with the motor to actuate the rack.

Preferably, at least one of the first and second couplers includes a connector base forming an external appearance of the at least one coupler; a pair of screw shafts being located in both sides of the connector base, each screw shaft having one end portion coupled to the video card or the monitor and the other end portion being formed with rotating means; a connector port being located in one end portion of the connector base in a connection direction of the video card or the monitor and including a connecting terminal formed in a portion connected to the video card or the monitor; a connector cable being located in the other end portion of the connector base in a direction opposite to the connection direction of the video card or the monitor for transmitting an analog video signal inputted/outputted to the video card or the monitor or a control signal inputted from a controller; a motor being located in the connector base and rotating according to the control signal inputted from the controller; a rack being located in a direction from the motor to the connector cable and having a pair of holes formed in both sides of the rack, the rack being interlocked with the motor so that the screw shafts inserted in the pair of holes can be rotated or not; and a connector cover being combined with the connector base to form an external appearance of the at least one coupler.

Preferably, the screw shafts are formed with slots in rotational axes of the rotating means and each of the holes of the rack has two integrated portions having different diameters, and the slots of the screw shafts are located in a portion having a larger diameter in each of the holes of the rack so that the screw shafts can be rotated at the time of decoupling, and the slots of the screw shafts are located in a portion having a smaller diameter in each of the holes of the rack so that the screw shafts can not be rotated at the time of coupling.

Preferably, the at least one coupler further includes a gear located between the motor and the rack and interlocked with the motor to actuate the rack.

Preferably, at least one of the first and second couplers includes a solenoid to control coupling/decoupling to/from the video card or the monitor, and is coupled to and physically locked in the video card or the monitor.

According to a third aspect of the present invention, there is provided a computer display monitoring apparatus provided between a video card of a computer and a monitor for outputting a video signal inputted from the video card to the monitor and monitoring the video signal, including a coupler including a connector base forming an external appearance of the coupler; a pair of screw shafts being located in both sides of the connector base, each screw shaft having one end portion coupled to the video card or the monitor and the other end portion being formed with a slot for rotation; a connector port being located in one end portion of the connector base in a connection direction of the video card or the monitor and including a connecting terminal formed in a portion connected to the video card or the monitor; a connector cable being located in the other end portion of the connector base in a direction opposite to the connection direction of the video card or the monitor for transmitting an analog video signal inputted/outputted to the video card or the monitor or a control signal inputted from the outside; a motor being located in the connector base and rotating according to the control signal inputted from the outside; a rack being located in a direction from the motor to the connector cable and having a pair of holes formed in both sides of the rack, the rack being interlocked with the motor, the pair of holes being aligned with the slots of the pair of screw shafts to expose the slots of the pair of screw shafts or to prevent the slots of the pair of screw shafts from being exposed; and a connector cover being combined with the connector base to form an external appearance of the coupler.

Preferably, the coupler further includes a gear located between the motor and the rack and interlocked with the motor to actuate the rack.

Preferably, the computer display monitoring apparatus further includes an extensible connecting cable connecting the coupler to a connecting part located in the computer display monitoring apparatus.

According to a fourth aspect of the present invention, there is provided a computer display monitoring apparatus provided between a video card of a computer and a monitor for outputting a video signal inputted from the video card to the monitor and monitoring the video signal, including a coupler including a connector base forming an external appearance of the coupler; a pair of screw shafts being located in both sides of the connector base, each screw shaft having one end portion coupled to the video card or the monitor and the other end portion being formed with rotating means; a connector port being located in one end portion of the connector base in a connection direction of the video card or the monitor and including a connecting terminal formed in a portion connected to the video card or the monitor; a connector cable being located in the other end portion of the connector base in a direction opposite to the connection direction of the video card or the monitor for transmitting an analog video signal inputted/outputted to the video card or the monitor or a control signal inputted from a controller; a motor being located in the connector base and rotating according to the control signal inputted from the controller; a rack being located in a direction from the motor to the connector cable and having a pair of holes formed in both sides of the rack, the rack being interlocked with the motor so that the screw shafts inserted in the pair of holes can be rotated or not; and a connector cover being combined with the connector base to form an external appearance of the coupler.

Preferably, the screw shafts are formed with slots in rotational axes of the rotating means and each of the holes of the rack has two integrated portions having different diameters, and the slots of the screw shafts are located in a portion having a larger diameter in each of the holes of the rack so that the screw shafts can be rotated at the time of decoupling, and the slots of the screw shafts are located in a portion having a smaller diameter in each of the holes of the rack so that the screw shafts can not be rotated at the time of coupling.

Preferably, the coupler further includes a gear located between the motor and the rack and interlocked with the motor to actuate the rack.

Preferably, the computer display monitoring apparatus further includes an extensible connecting cable connecting the coupler to a connecting part located in the computer display monitoring apparatus.

According to a fifth aspect of the present invention, there is provided a computer display monitoring method comprising the steps of (A) physically locking one of a first coupler and a second coupler to be coupled to a video card and a monitor, respectively, in the video card or the monitor as a rack prevents a pair of screw shafts from rotating, the rack being interlocked with a motor rotating according to a control signal inputted from a controller; (B) converting a first analog video signal inputted from the video card through the first coupler into a digital video signal; (C) compressing and storing the digital video signal at a preset time interval; (D) decompressing the stored digital video signal and converting the decompressed digital video signal into a second analog video signal to be reproduced in the monitor; and (E) transmitting the second analog video signal to the monitor through the second coupler.

Preferably, the step (A) further includes (A-1) physically locking the other of the first coupler and the second coupler to be coupled to an external device including the video card and the monitor in the external device by using a solenoid to control coupling/decoupling to/from the external device.

Preferably, the step (B) further includes (B-1) transmitting the first analog video signal inputted from the video card through the first coupler to the monitor.

Preferably, the step (D) further includes (D-1) preventing the first analog video signal inputted from the video card through the first coupler from being transmitted to the monitor.

Programs relating to the above computer display monitoring method may be stored in a server computer readable record medium. The record medium includes all kinds of record medium in which programs and data are stored so that they can be read by a computer system. For example, the record medium may include a ROM (Read Only Memory), a RAM (Random Access Memory), a CD (Compact Disk), a DVD (Digital Video Disk)-ROM, a magnetic tape, a floppy disk, an optical data storage, etc., and may be implemented with the form of carrier waves (for example, transmission through the Internet). In addition, the record medium may be distributed in computer systems interconnected by a network so that computer readable codes can be stored and executed in a distributed processing system.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a view illustrating a configuration of a computer display monitoring system according to the present invention;

FIG. 2 is a flow chart illustrating a process of capturing video information outputted from a computer according to the present invention;

FIG. 3 is a flow chart illustrating a process of reproducing video information stored in a computer display monitoring display apparatus according to the present invention;

FIG. 4 is a view illustrating a configuration of a computer display monitoring system according to an exemplary embodiment of the present invention;

FIG. 5 is a view illustrating a detailed configuration of a computer display monitoring system according to an exemplary embodiment of the present invention;

FIG. 6 is a view illustrating a detailed configuration of a computer display monitoring system according to another exemplary embodiment of the present invention;

FIG. 7 is a perspective view illustrating an external appearance of a computer display monitoring apparatus according to an exemplary embodiment of the present invention;

FIG. 8 is a flow chart illustrating a process of controlling a monitor in a computer display monitoring apparatus according to an exemplary embodiment of the present invention;

FIG. 9 is a flow chart illustrating an operating process for each mode of a computer display monitoring apparatus according to an exemplary embodiment of the present invention;

FIG. 10 is a flow chart illustrating a process of setting up a computer display monitoring apparatus according to an exemplary embodiment of the present invention;

FIG. 11 is a plan view of a coupler in a computer display monitoring apparatus according to a first embodiment of the present invention;

FIG. 12 is a sectional view of the coupler in the computer display monitoring apparatus according to the first embodiment of the present invention;

FIG. 13 is an exploded perspective view of a coupler in a computer display monitoring apparatus according to a second embodiment of the present invention;

FIG. 14 is a view showing a structure of the coupler in the computer display monitoring apparatus according to the second embodiment of the present invention;

FIG. 15 is a perspective view of a gear in the coupler in the computer display monitoring apparatus according to the second embodiment of the present invention;

FIG. 16 is a structural view showing a decoupled state of the coupler in the computer display monitoring apparatus according to the second embodiment of the present invention;

FIG. 17 is a front view showing the decoupled state of the coupler in the computer display monitoring apparatus according to the second embodiment of the present invention;

FIG. 18 is a structural view showing a coupled state of the coupler in the computer display monitoring apparatus according to the second embodiment of the present invention;

FIG. 19 is a front view showing the coupled state of the coupler in the computer display monitoring apparatus according to the second embodiment of the present invention;

FIG. 20 is an exploded perspective view of a coupler in a computer display monitoring apparatus according to a third embodiment of the present invention;

FIG. 21 is a view showing a structure of the coupler in the computer display monitoring apparatus according to the third embodiment of the present invention;

FIG. 22 is a structural view showing a decoupled state of the coupler in the computer display monitoring apparatus according to the third embodiment of the present invention;

FIG. 23 is a front view showing the decoupled state of the coupler in the computer display monitoring apparatus according to the third embodiment of the present invention;

FIG. 24 is a structural view showing a coupled state of the coupler in the computer display monitoring apparatus according to the third embodiment of the present invention;

FIG. 25 is a front view showing the coupled state of the coupler in the computer display monitoring apparatus according to the third embodiment of the present invention;

FIG. 26 is a structural view showing a connected state of a general computer cable; and

FIG. 27 is a structural view showing a connected state in a first coupler and a second coupler in a computer display monitoring apparatus according to an exemplary embodiment of the present invention.

### DETAILED DESCRIPTION OF THE PREFERRED EMBODIMENT

Reference will now be made in detail to exemplary embodiments of the present invention, examples of which are illustrated in the accompanying drawings.

The present invention suggests a computer display monitoring apparatus provided between a computer and a monitor for monitoring a picture outputted from the computer and displayed on the monitor. The computer is coupled to the computer display monitoring apparatus by a first coupler, and also the monitor is coupled to the computer display monitoring apparatus by a second coupler. The first and second couplers are physically coupled to or decoupled from the computer display monitoring apparatus by means of an electrical control signal such that the computer display monitoring apparatus can not be forcibly detached from the computer and the monitor.

As an exemplary implementation of the computer display monitoring apparatus, the present invention suggests a hardware implementation including all configurations for display monitor in the computer display monitoring apparatus by monitoring computer display through a direct control in the computer display monitoring apparatus. As another exemplary implementation of the computer display monitoring apparatus, the present invention suggests a software implementation allowing the computer to control the computer display monitoring apparatus by causing various operating programs pre-stored in the computer display monitoring apparatus to be automatically installed in the computer when the computer display monitoring apparatus is connected to the computer.

In addition, the present invention suggests a method of using a solenoid and a stepping motor to prevent couplers coupling the computer display monitoring apparatus to the computer and the monitor from being forcibly detached from the computer and the monitor.

Hereinafter, exemplary embodiments of the present invention will be described in detail in conjunction with the accompanying drawings. The following embodiments are provided to make those in the art understand the spirit of the invention more fully. However, the following embodiments may be modified and changed in many ways and should not be construed to limit the scope of the invention.

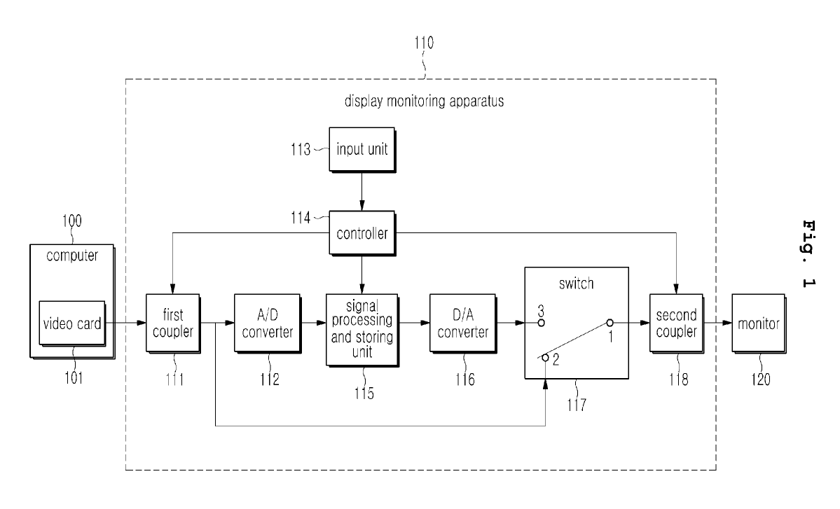

First, the concept of a computer display monitoring system and a display monitoring method using the system in accordance with the present invention will be described with reference to FIGS. 1 to 3.

FIG. 1 is a view illustrating a configuration of a computer display monitoring system according to the present invention.

Referring to FIG. 1, a computer display monitoring system comprises a computer 100, a computer display monitoring apparatus 110 and a monitor 120. The computer display monitoring apparatus 110 includes a first coupler 111, an A/D (analog-to-digital) converter 112, an input unit 113, a controller 114, a signal processing and storing unit 115, a D/A (digital-to-analog) converter 116, a switch 117, and a second coupler 118. The computer display monitoring apparatus 110 is located between the computer 100 and the monitor and performs a function of capturing, storing, reproducing and controlling a video signal transmitted from the computer 100 to the monitor 120.

The first coupler 111 couples the computer display monitoring apparatus 110 to a video card 101 built in the computer 100 so tightly that the computer display monitoring apparatus 110 can not be detached from the video card 101 without any electrical control signal. Also, the first coupler 111 performs a function of transmitting an analog video signal from the video card 101 to the A/D converter 112.

The A/D converter 112 converts the analog video signal from the video card 101 into a digital video signal. The analog video signal inputted to the A/D converter 112 has continuous function values in a time domain and is carried by a carrier for RGB (Red, Green and Blue) color signals. The A/D converter 112 converts the analog video signal having the continuous function values into the digital video signal having discrete function values for more efficient video processing. It is preferable that the A/D converter 112 converts the analog video signal into the digital video signal using an IC chip(Integrated Circuit Chip).

The input unit 113 is inputted with a password of the computer display monitoring apparatus 110, a set IC card, access data of an input button or the like. In addition, the input unit 113 is inputted with a control signal of the controller 114 from the outside (for example, an authorized operator). Specifically, when the controller 114 controls a time interval at which the signal processing and storing unit 115 compresses and stores a video signal and controls the signal processing and storing unit 115 to read and reproduce the stored video signal later, a signal to set such control is inputted through the input unit 113.

The controller 114 controls a period of time taken for the signal processing and storing unit 115 to compress and store the video signal outputted from the video card 101 of the computer 100 and the amount of the compression of the video signal, and controls restoration and reproduction of the compressed and stored video signal later. That is, the signal processing and storing unit 115 may compress and store the video signal at once or at set intervals, and the controller 114 may set and control a period of time taken for such compression and store of the video signal and the amount of the compression. In other words, the controller 114 controls the amount of storage of the compressed video signal in a memory. For example, the controller 114 may control the signal processing and storing unit 115 to compress and store the video signal outputted from video card 101 at an interval of ten minutes or at once. However, the latter requires a large amount of storage space, and accordingly, an appropriate time interval is preferably set in consideration of capacity of the memory.

In addition, the controller 114 controls the first coupler 111 and the second coupler 118. In more detail, the controller 114 controls coupling and decoupling between the computer display monitoring apparatus 110 and the computer 100 or between the computer display monitoring apparatus 110 and the monitor 120. In other words, if the first coupler 111 or the second coupler 118 is not inputted with a control signal related to the decoupling from the controller 114, the computer display monitoring apparatus 110 can not be decoupled from the computer 100 or the monitor 120 at random.

As mentioned above, the signal processing and storing unit 115 performs a function of compressing the digital video signal inputted from the A/D converter 112 and storing the compressed digital video signal in an internal memory. In this embodiment, the digital video signal may be compressed in various ways including a JPEG (Joint Photographic Experts Group) coding method, which is an algorithm based on an ADCT (Adaptive Discrete Cosine Transform). According to the JPEG coding method, in the digital video signal inputted to the signal processing and storing unit 115, digital video information in a region beyond a limit on vision may be coded to exceptionally reduce the amount of data through a lossy compression method. As a result, for example, the signal processing and storing unit may store a JPEG video having the amount of data reduced to about 1/120 of the original amount of data while having the about same quality as an original video.

When an authorized operator is to restore the video compressed and stored in the signal processing and storing unit 115 later, the signal processing and storing unit 115 reads, decompresses and restores the compressed and stored video signal according to the control signal from the controller 114, converts the restored video signal into a digital video signal, and then outputs the digital video signal to the D/A converter 116. That is, when the authorized operator is to confirm the video stored in the memory of the signal processing and storing unit 115 through the monitor 120, the controller 114 outputs the control signal to the signal processing and storing unit 115 to convert the compressed video signal stored in the memory of the signal processing and storing unit 115 into the digital video signal.

The D/A converter 116 converts the digital video signal inputted from the signal processing and storing unit 115 into an analog video signal, which is reproducible in the monitor 120, to be outputted to the switch 117. That is, the D/A converter 116 converts the compressed digital video signal stored in the memory of the signal processing and storing unit 115 into the analog video signal to be transmitted to and displayed on the monitor 120.

The switch 117 is operable in two modes; first and second modes, while the computer 100 is powered on.

First, in the first mode, a terminal 1 of the switch 117 is connected to a terminal 2 of the switch 117. In this case, the analog video signal outputted from the video card 101 of the computer 100 is simultaneously inputted to the A/D converter 112 and the switch 117. The analog video signal inputted to the A/D converter 112 is compressed by and stored in the signal processing and storing unit 115, as described above, and the analog video signal inputted to the switch 117 is inputted to and displayed on the monitor 120 via the terminals 1 and 2. The first mode is a typical case in which a computer user uses the computer 100 and video information is compressed by and stored in the signal processing and storing unit 115 while being displayed on the monitor 120.

Next, in the second mode, the terminal 1 of the switch 117 is connected to a terminal 3 of the switch 117. In this case, an authorized operator restores and confirms the video stored in the signal processing and storing unit 115. In the second mode, the analog video signal outputted from the video card 101 of the computer 100 is prevented from directly being transmitted to the monitor 120 through the switch 117 and the analog video signal outputted from the D/A converter 116 is displayed on the monitor 120, thus allowing the authorized operator to display the compressed video signal stored in the signal processing and storing unit 115 on the monitor 120 in order to confirm and monitor the video.

Similarly to the first coupler 111, the second coupler 118 couples the computer display monitoring apparatus 110 to the monitor 120 so tightly that the computer display monitoring apparatus 110 can not be detached from the monitor 120 without any electrical control signal. Also, the second coupler 118 performs a function of transmitting an analog video signal from the switch 117 to the monitor 120.

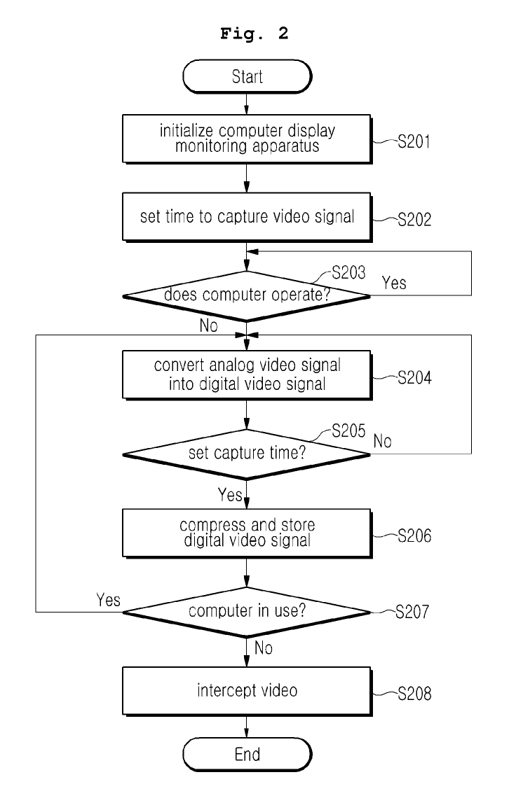

FIG. 2 is a flow chart illustrating a process of capturing video information outputted from the computer 100 in the condition that the terminal 1 of the switch 117 in the computer display monitoring apparatus 110 is connected to the terminal 2, according to the present invention.

Referring to FIG. 2, first, the computer display monitoring apparatus 110 is initialized at Step S201.

Next, the controller 114 of the computer display monitoring apparatus 110 sets time for which the video signal inputted from the video card 101 of the computer 100 through the first coupler 111 is captured at Step S202. This time setting refers to setting of a time interval for capture of the video. If the time interval is set to be zero, the video being displayed is all captured. In this case, since the enormous amount of capacity of the memory is required to capture the entire video of the computer 100, it is desirable to set an appropriate time interval to capture a portion of the video.

Next, the controller 114 of the computer display monitoring apparatus 110 confirms whether or not the computer 100 operates at Step S203. When the computer 100 operates, the A/D converter 112 of the computer display monitoring apparatus 110 converts an analog video signal inputted from the video card 101 of the computer 100 into a digital video signal at Step S204.

Next, the controller 114 of the computer display monitoring apparatus 110 confirms whether or not the capture time set in Step S202 comes at Step S205. If it is confirmed that the set capture time does not come, the computer display monitoring apparatus 110 continues to perform Step S204.

On the other hand, if the set capture time elapses, the signal processing and storing unit 115 of the computer display monitoring apparatus 110 compresses and stores the digital video signal at Step S206. In this case, the digital video signal may be compressed in various ways including, for example, a JPEG coding method based on an ADCT.

Next, the controller 114 of the computer display monitoring apparatus 110 determines whether or not the computer 100 continues to operate at Step S207. If it is determined that the computer 100 continues to operate, the computer display monitoring apparatus 110 continues to repeatedly perform Steps S204 through S206. If it is determined that the computer 100 does not operate, the computer display monitoring display apparatus 110 intercepts the video at Step S208 and terminates the video capture process.

While a series of processes for capturing the analog video signal from the computer 100 is being progressed, the terminal 1 of the switch 117 in the computer display monitoring apparatus 110 is connected to the terminal 2 to transmit the analog video signal to the monitor 120 on which the video is displayed. That is, while a user uses the computer 100, the computer display monitoring apparatus 110 captures and stores the video outputted to the monitor 120 at a set time interval.

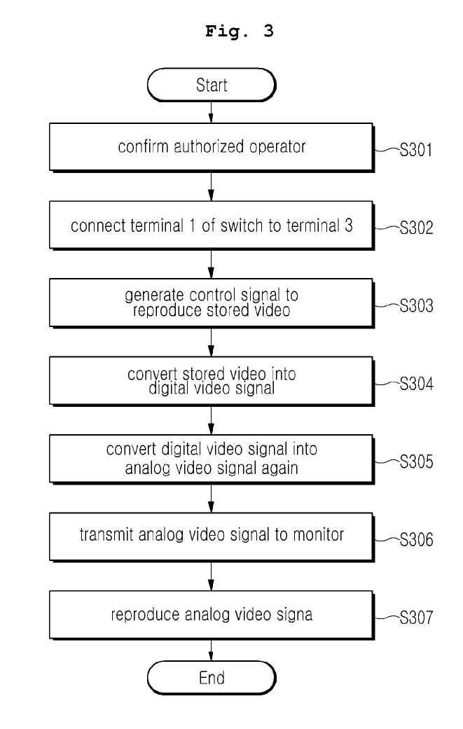

FIG. 3 is a flow chart illustrating a process of reproducing video information stored in the computer display monitoring apparatus according to the present invention.

Referring to FIG. 3, the computer display monitoring apparatus 110 confirms whether or not an operator is authorized by means of an access signal inputted through an IC card, an input button or the like at Step S301. At this time, the access to the computer display monitoring apparatus 110 may be made through various methods including fingerprint recognition, iris recognition and so on, in addition to the IC card and the input button.

Next, the terminal 1 of the switch 117 in the computer display monitoring apparatus 110 is connected to the terminal 3 at Step S302. Then, the video signal transmitted directly from the video card 101 of the computer 100 to the monitor 120 is intercepted and the video stored in the signal processing and storing unit 115 is restored and displayed on the monitor 120.

Next, the controller 114 of the computer display monitoring apparatus 110 generates a reproduction control signal for the video stored in the signal processing and storing unit 115 at Step S303, and the signal processing and storing unit 115 converts the stored video signal into a digital video signal at Step S304.

Next, the D/A converter 116 in the computer display monitoring display apparatus 110 again converts the digital video signal into an analog video signal to be transmitted to and reproduced in the monitor 120 via the switch 117 and the second coupler 118 at Step S306.

Then, the monitor 120 receives and reproduces the analog video signal at Step S307. In this case, the analog video signal may be reproduced as a moving picture or a still image.

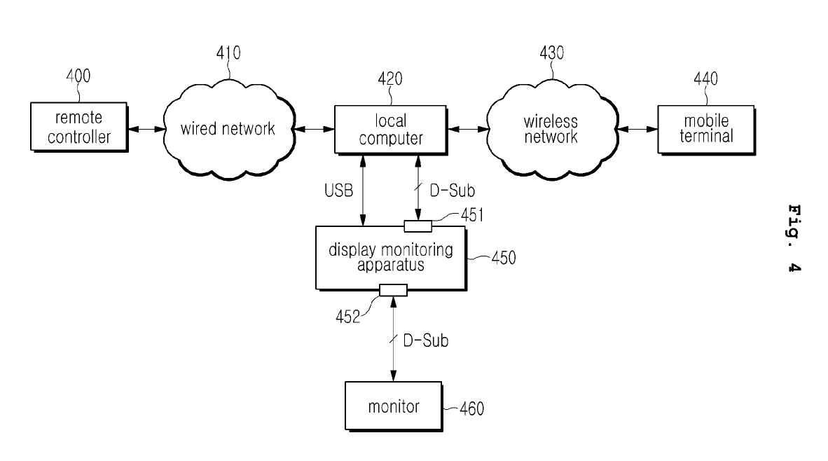

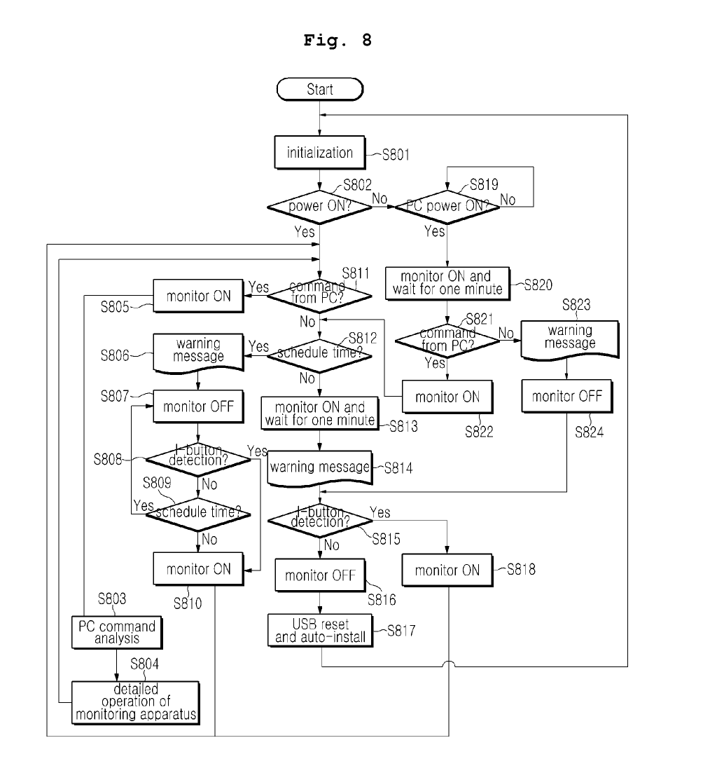

Hereinafter, the computer display monitoring apparatus, the system including the same, and the computer display monitoring method according to the embodiment of the present invention will be described in more detail with reference to FIGS. 4 to 10. First, the computer display monitoring display apparatus and the system including the same will be described with reference to FIGS. 4 to 7, and then the computer display monitoring method will be described with reference to FIGS. 8 to 10.

FIG. 4 is a view illustrating a configuration of a computer display monitoring system according to an embodiment of the present invention. Referring to FIG. 4, the computer display monitoring system may include a remote computer 400, a wired network 410, a local computer 420, a wireless network 430, a mobile terminal 440, a computer display monitoring apparatus 450, a monitor 460 and so on.

As described above, the computer display monitoring apparatus 450 is provided between the local computer 420 and the monitor 460. In this case, the local computer 420 is physically coupled to the computer display monitoring apparatus 450 by means of a first coupler 451 so tightly that they can not be detached from each other without any electrical signal, and similarly, the computer display monitoring apparatus 450 is physically coupled to the monitor 460 by means of a second coupler 452 so tightly that they can not be detached from each other without any electrical signal. A D-Sub private cable for signal transmission for output of computer display is preferably connected between the local computer 420 and the computer display monitoring apparatus 450 and between the computer display monitoring apparatus 450 and the monitor 460, but it is obvious that various different cables can be used depending on various transmission systems, in addition to the D-Sub private cable.

Also, a separate universal serial bus (USB) cable may be additionally connected between the local computer 420 and the computer display monitoring apparatus 450. This USB cable enables various controls such as actuation of the first and second couplers 451 and 452 of the computer display monitoring apparatus 450, turning on/off of the monitor 460, image data transmission, recognition of button input and so on.

In addition, it may be configured that the remote computer 400 controls the computer display monitoring apparatus 450 through the wired network 410 and the mobile terminal 440 controls the computer display monitoring apparatus 450 through the wireless network 430.

That is, a computer or a mobile terminal at a remote place (for example, an office or an Internet café) may monitor or control a video transmitted to the monitor 460 connected to the local computer 420 at home.

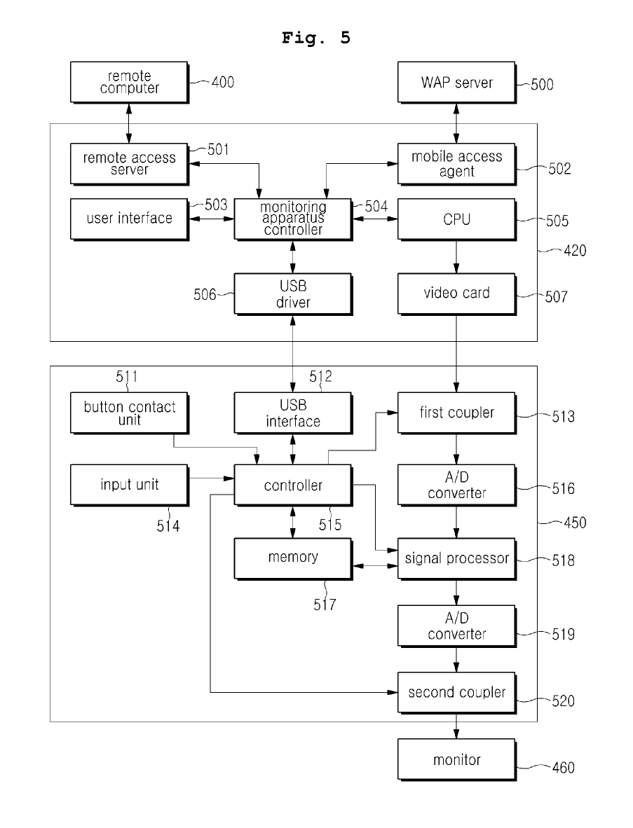

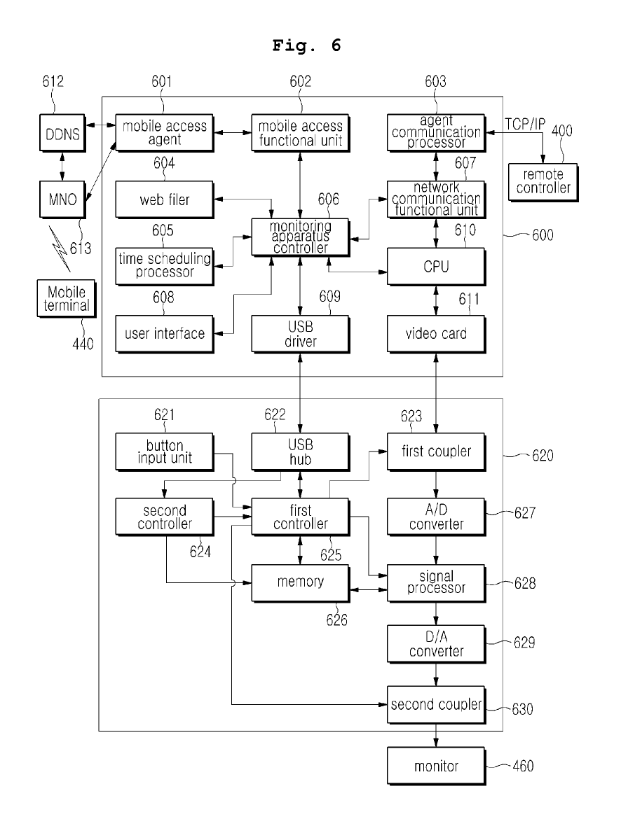

Hereinafter, a detailed configuration of the computer display monitoring system illustrated in FIG. 4 will be described in detail with reference to FIGS. 5 and 6. FIG. 5 shows a hardware implementation including all configurations for display monitor in the computer display monitoring apparatus by monitoring computer display through a direct control in the computer display monitoring apparatus. FIG. 6 shows a software implementation allowing the computer to control the computer display monitoring apparatus by causing various operating programs pre-stored in the computer display monitoring apparatus to be automatically installed in the computer when the computer display monitoring apparatus is connected to the computer.

FIG. 5 is a view illustrating a detailed configuration of a computer display monitoring system according to an exemplary embodiment of the present invention. Referring to FIG. 5, the computer display monitoring system may include a remote computer 400, a WAP server 500, a local computer 420, a computer display monitoring apparatus 450, and a monitor 460. The local computer 420 may include a remote access server 501, a mobile access agent 502, a user interface 503, a monitoring apparatus controller 504, a CPU (central processing unit) 505, a USB driver 506, a video card 507, etc., and the computer display monitoring apparatus 450 may include a button contact unit 511, a USB interface 512, a first coupler 513, an input unit 514, a controller 515, an A/D converter 516, a memory 517, a signal processor 518, a D/A converter 519, a second coupler 520, etc.

The monitoring apparatus controller 504 of the local computer 420 exchanges a control signal with the controller 515 of computer display monitoring apparatus 450 through USB communication. That is, the monitoring apparatus controller 504 is USB-coupled to the computer display monitoring apparatus 450 through the USB driver 506, and the computer display monitoring apparatus 450 is USB-coupled to the local computer 420 through the USB interface 512.

A video signal is outputted from the video card 507 of the local computer 420 to the computer display monitoring apparatus 450 through the first coupler 513. The video signal inputted to the computer display monitoring apparatus 450 is outputted to the monitor 460 through the second coupler 520 according to a control signal from the controller 515. The video signal inputted through the first coupler 513 is processed according to the above-described method illustrated in FIG. 1.

The computer display monitoring apparatus 450 compresses, stores and outputs the video signal inputted through the first coupler 513. Specifically, the video signal inputted through the first coupler 513 is converted into a digital video signal by the A/D converter 516 according to the control signal from the controller 515, and then the digital video signal is inputted to the signal processor 518. The signal processor 518 compresses the digital video signal and stores the compressed video signal in the memory 517. When the video signal stored in the memory 517 is to be confirmed, the signal processor decompresses the stored video signal. Then, the D/A converter 519 converts the decompressed video signal into an analog video signal to be outputted to the monitor 460 through the second coupler 520.

An operator of the computer display monitoring apparatus 450 may input a control signal through the input unit 514. Also, when a separate non-contact (or contact) means contacts the button contact unit 511 of the computer display monitoring apparatus 450, the button contact unit 511 performs a user authentication function.

The controller 515 conducts a USB communication with the local computer 420, as described above, to receive various control signals from the local computer 420. In addition, the controller 515 controls the first and second couplers 513 and 520 such that the computer display monitoring apparatus 450 is physically decoupled from the local computer 420 and the monitor 460 by an external force.

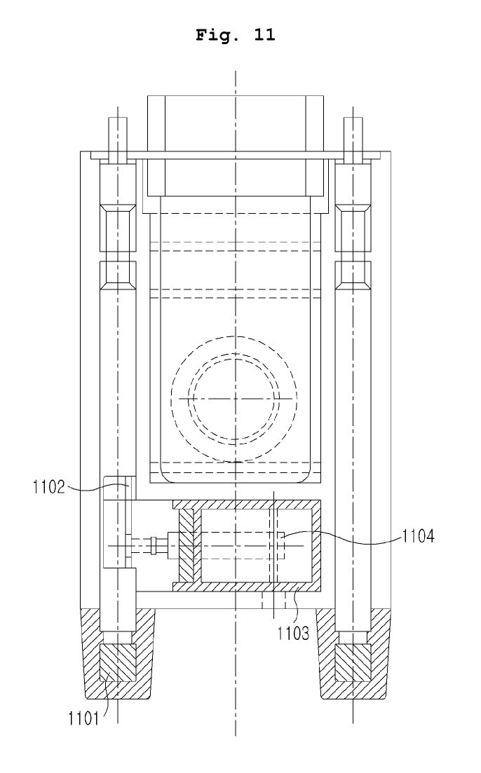

That is, the first and second couplers 513 and 520 has a physical structure to couple/decouple the computer display monitoring apparatus 450 to/from the local computer 420 and the monitor 460 according to the control signal from the controller 515, as described above. For example, the first and second couplers 513 and 520 may include a solenoid, a stepping motor or the like to enable a physical coupling/decoupling according to the control signal from the controller 515, which will be described in detail later with reference to FIG. 11 and the subsequent figures.

The computer display monitoring apparatus 450 can perform the computer display monitoring function for itself when an operator is authenticated through the button contact unit 511 and the control signal is received through the input part 514. That is, it is possible to control the computer display monitoring apparatus 450 even when the control signal is not received through the USB communication.

In addition, as described above, the local computer 420 may control the computer display monitoring apparatus 450 through the USB communication, and the monitoring apparatus controller 504 can confirm a stored video or control use of a PC through a network by communicating with the remote computer 400 through the remote access server 501. In addition, the monitoring apparatus controller 504 can confirm a video or control use of a PC through a mobile terminal (i.e., a portable telephone) by communicating with the WAP server 500 through the mobile access agent 502.

FIG. 6 is a view illustrating a detailed configuration of a according to another exemplary embodiment of the present invention. In this embodiment, when a computer display monitoring apparatus is connected to a local computer, a control program for the computer display monitoring apparatus 620 is automatically installed in the local computer to control the computer display monitoring apparatus.

Referring to FIG. 6, the computer display monitoring system may include a remote computer 400, a local computer 600, a computer display monitoring apparatus 620, a monitor 460, a DDNS (dynamic domain name server) 612, an MNO (mobile network operator) 613, and a mobile terminal 440. The local computer 600 may include a mobile access agent 601, a mobile access functional unit 602, an agent communication processor 603, a web filer 604, a time scheduling processor 605, a monitoring apparatus controller 606, a network communication functional unit 607, a user interface 608, a USB driver 609, a CPU 610, a video card 611, etc., and the computer display monitoring apparatus 620 may include a button input unit 621, a USB hub 622, a first coupler 623, a first controller 625, a second controller 624, a memory 626, an A/D converter 627, a signal processor 628, a D/A converter 629, a second coupler 630, etc.

A process in which the computer display monitoring apparatus 620 receives a video signal outputted from the video card 611 of the local computer 600 through the first coupler 623 is the same as the process illustrated in FIG. 5.

The video signal inputted to the computer display monitoring apparatus 620 through the first coupler 623 is outputted to the monitor 460 through the second coupler 630 according to a control signal from the first controller 625. The video signal inputted through the first coupler 623 is processed according to the above-described method illustrated in FIG. 1.

The computer display monitoring apparatus 620 compresses, stores and outputs the video signal inputted through the first coupler 623. Specifically, the video signal inputted through the first coupler 623 is converted into a digital video signal by the A/D converter 627 according to the control signal from the first controller 625, and then the digital video signal is inputted to the signal processor 628. The signal processor 628 compresses the digital video signal and stores the compressed video signal in the memory 626. When the video signal stored in the memory 626 is to be confirmed, the signal processor 628 decompresses the stored video signal. Then, the D/A converter 629 converts the decompressed video signal into an analog video signal to be outputted to the monitor 460 through the second coupler 630.

As described above, in this embodiment, when the local computer 600 is USB-connected to the computer display monitoring apparatus 620, various control softwares for control of the computer display monitoring apparatus 620 are automatically installed from the computer display monitoring apparatus 620 into the local computer 600.

Specifically, various control softwares for control of the computer display monitoring apparatus 620 (for example, a computer display monitoring apparatus control program installed in the monitoring apparatus controller 606 of the local computer 600, a USB device driver for the computer display monitoring apparatus 620, a remote control program, etc.) are stored in the second controller 624. Accordingly, as soon as the local computer 600 establishes a USB communication with the computer display monitoring apparatus 620, the local computer 600 recognizes the computer display monitoring apparatus 620 as an external device and then loads and installs various control softwares stored in the second controller 624.

The second controller 624 may include a flash memory (for example, an NAND flash memory) and may be virtualized as a CD-ROM. Thus, an OS (operating system) (for example, Windows) installed in the local computer 600 can recognize the second controller 624 of the computer display monitoring apparatus 620 as the CD-ROM. Accordingly, the OS of the local computer 600 performs an auto-run function supported by itself.

Then, the second controller 624 is connected by a USB cable to the local computer 600 through the USB hub 622 and exchanges control commands and state values with the local computer 600 by communicating with application programs of the OS through the USB communication. Programs transmitted from the second controller 624 to the local computer 600 and executed in the local computer 600 may include a program for transmission of image data to a mobile terminal, a harmful site blocking program, a video capture, compression and storage program, a remote access program through a network, etc.

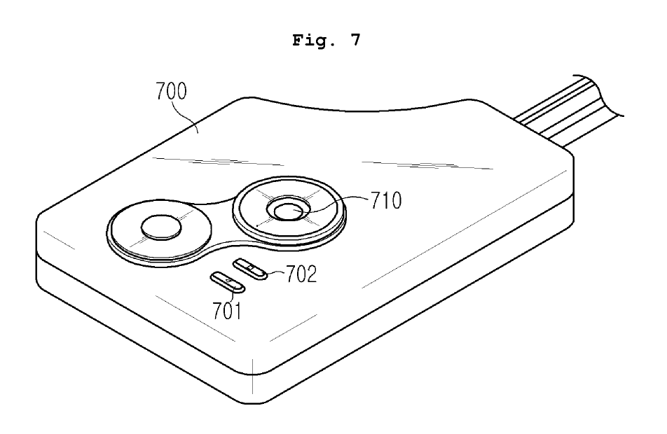

FIG. 7 is a perspective view illustrating an external appearance of a computer display monitoring apparatus according to an exemplary embodiment of the present invention. Referring to FIG. 7, a computer display monitoring apparatus 700 is connected to a local computer and a monitor through two video signal transmission cables (for example, D-Sub cables), respectively, and is additionally connected to the local computer through a USB cable.

Also, on an apparatus case of the computer display monitoring apparatus 700 is provided input buttons 701 and 702 through which a control signal can be directly inputted, and means (for example, I-button) for authentication on an operator. For example, the operator can be authenticated when he contacts separate authentication means with a button contact unit 710.

Hereinafter, a computer display monitoring method, particularly, including the above-described process of automatically installing the control softwares, using the above-described computer display monitoring apparatus will be described in detail with reference to FIGS. 8 to 10.

FIG. 8 is a flow chart illustrating a process of controlling a monitor in a computer display monitoring apparatus according to an exemplary embodiment of the present invention. Referring to FIG. 8, when the computer display monitoring apparatus is initialized at Step S801 and is powered on at Step S802, it checks whether or not a command is inputted from a PC to the computer display monitoring apparatus at Step S811. If the computer display monitoring apparatus receives the command from the PC, the monitor is turned on at Step S805 and the computer display monitoring apparatus analyzes the received command to perform a detailed operation at Step S804.

If the computer display monitoring apparatus is powered off at Step S802, the monitor is turned on and waits for one minute at Step S820 when the PC is powered on at Step S819. Then, the computer display monitoring apparatus checks whether or not a command is inputted from the PC to the computer display monitoring apparatus at Step S821. When the computer display monitoring apparatus receives the command from the PC, the monitor keeps turned on at Step S822. However, if the computer display monitoring apparatus does not receive the command from the PC, the computer display monitoring apparatus 620 regards use of the PC as unauthorized use and turns off the monitor at Step S824 after outputting a warning message to the monitor at Step S823.

If the computer display monitoring apparatus does not receive the command from the PC at the Step S811 or after the monitor is turned off at the Step S822, a preset schedule time is checked at Step S812. If it is checked that the schedule time elapses, the warning message is outputted to the monitor at Step S806 and then the monitor is turned off at Step S807. At this time, when an authorized operator is authenticated through authentication means (for example, I-button) of the computer display monitoring apparatus 620 at Step S808, the monitor is turned on again at Step S810. Alternatively, the monitor is turned on at the Step S810 when the preset schedule time ends at Step S809.

If the preset schedule time does not elapse at the Step S812, the monitor is turned on and waits for one minute at Step S813. Then, a warning message is outputted to the monitor at Step S814. In the mean time, when the I-button is detected by authenticating an authorized operator at Step S815, the monitor is turned on again at Step S818. On the contrary, if the authorized operator is not authenticated, the monitor is turned off at Step S816, and then a USB is reset and an automatic program installation is performed at Step S817.

Through the above-described process, the monitor can be monitored and controlled using the computer display monitoring apparatus.

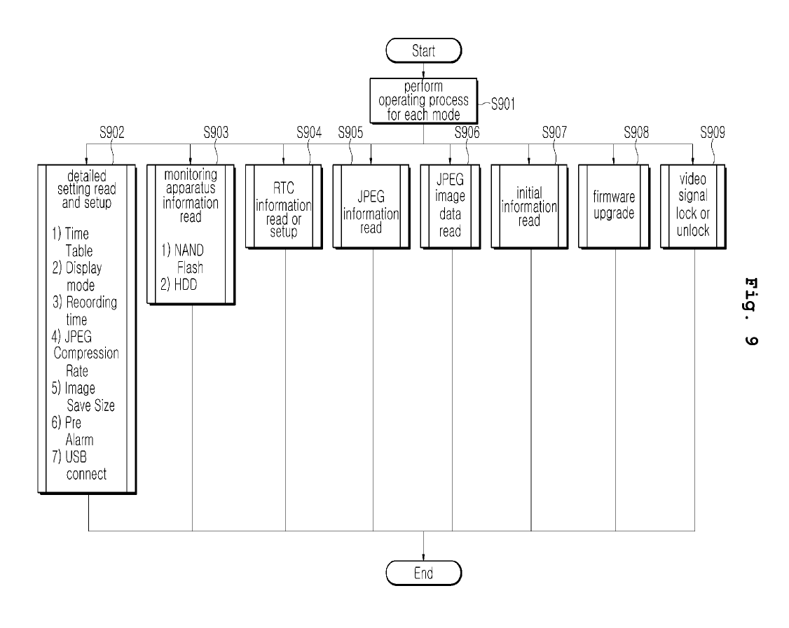

FIG. 9 is a flow chart illustrating an operating process for each mode of a computer display monitoring apparatus according to an exemplary embodiment of the present invention. Referring to FIG. 9, when the computer display monitoring apparatus is powered on and receives various control commands from the PC in FIG. 8, the computer display monitoring apparatus operates according to the control commands.

That is, the computer display monitoring apparatus performs an operating process for each mode according to the received control command at Step S901. First, if a received control command is a detailed setting read and setup command at Step S902, a time table, a display mode, a recording time, a JPEG compression rate, an image save size, a pre-alarm, a USB connection, etc. are set according to contents of the received control command.

If the received control command is a monitoring apparatus information read command at Step S903, information stored in an NAND flash memory or a hard disk (HDD) is read. In addition, processes such as an RTC information read or setup at Step S904, a JPEG information read at Step S905, a JPEG image data read at Step S906, an initial information read at Step S907, a firmware upgrade at Step S908, a video signal lock or unlock at Step S909, etc. are performed.

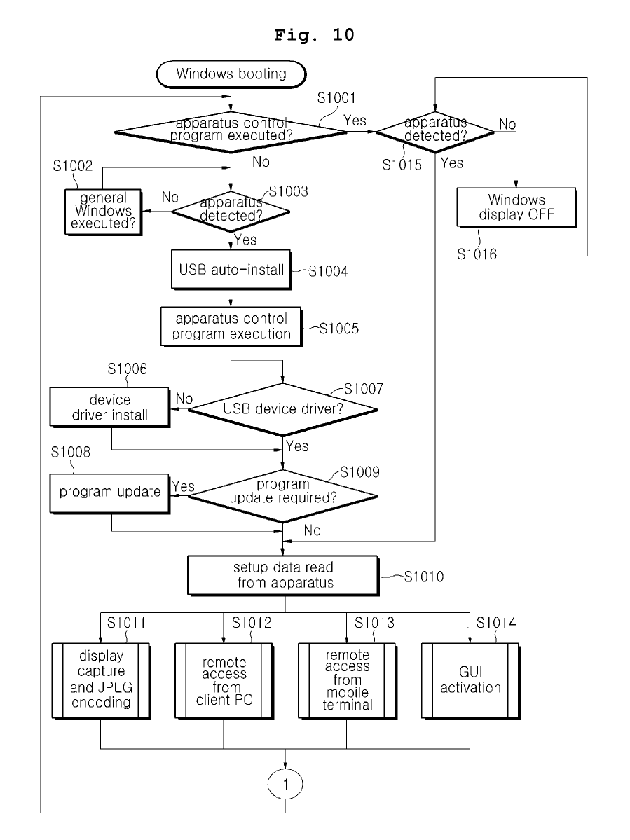

FIG. 10 is a flow chart illustrating a process of setting up a computer display monitoring apparatus according to an exemplary embodiment of the present invention. Referring to FIG. 10, when the local computer is connected to the computer display monitoring apparatus, as described above, the local computer can control the computer display monitoring apparatus effectively by installing the pre-stored control programs in the computer display monitoring apparatus.

Specifically, when the OS of the local computer is booted and a control program for the computer display monitoring apparatus is executed at Step S1001, it is checked whether or not a new apparatus is detected at Step S1015. If it is checked that the new apparatus is detected, setup data are read from the apparatus. Otherwise, a window display is turned off at Step S106.

On the other hand, when the computer display monitoring apparatus is detected although the control program is not executed at the time of booting the OS, the control program for the computer display monitoring apparatus is automatically installed. However, if the control program is not executed and the computer display monitoring apparatus is not detected, it means that the computer display monitoring apparatus is not installed, and accordingly, a general OS (Windows) system is executed at Step S1002.

If it is detected that the computer display monitoring apparatus is detected at Step S1003, the control program stored in the computer display monitoring apparatus is copied and installed into the local computer through an automatic installation process by USB at Step S1004. Then, the installed control program is executed at Step S1005.

If a USB device driver does not exist at Step S1007, the USB device driver is installed in the local computer at Step S1006. Also, if an update for the control program is needed at Step S1009, the control program is updated at Step S1008. Thus, after the control program is installed as described above, the setup data are read from the computer display monitoring apparatus at Step S1010. Then, according to respective control commands, display is captured and encoded by JPEG at Step S1011, a remote access is made from a client PC at Step S1012, a remote access is made from a mobile terminal at Step S1013, or a GUI is activated at Step S1014.

So far, the computer display monitoring system and method according to the embodiment of the present invention has been described.

Hereinafter, jointing means used in the first coupler or the second coupler coupling the above-described computer display monitoring apparatus to the local computer or the monitor will be described with reference to FIGS. 11 to 27. In the following embodiments, methods using a solenoid or a stepping motor as the jointing means will be described. These methods may be optionally applied to the first coupler or the second coupler. For example, the methods using the solenoid and the stepping motor may be applied to the first coupler and the second coupler, respectively. Alternatively, the method using the stepping motor may be applied to both of the first and second couplers. That is, the methods using the solenoid and the stepping motor may be optionally applied to one or both of the first and second couplers.

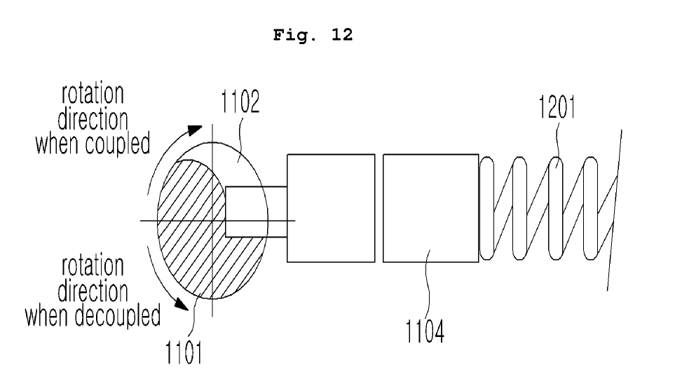

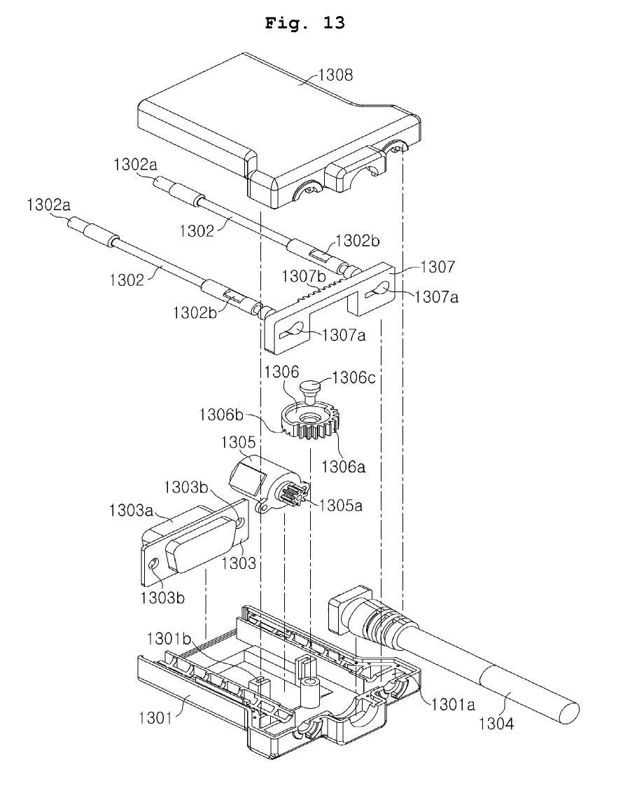

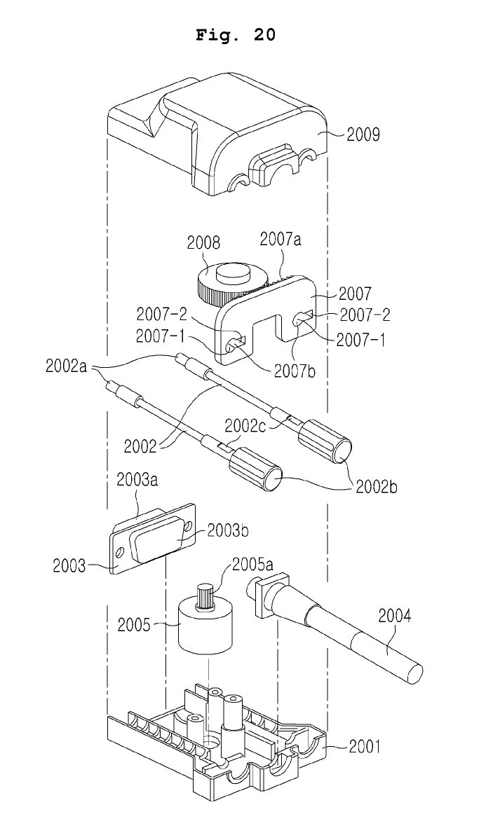

Hereinafter, a method using the solenoid according to a first embodiment will be described with reference to FIGS. 11 and 12, a method using the stepping motor according to a second embodiment will be described with reference to FIGS. 13 to 19, and a method using the stepping motor according to a third embodiment will be described with reference to FIGS. 20 to 25.

FIGS. 11 and 12 are a plan view and a sectional view of a coupler, respectively, which is provided with a locking device using a solenoid-type connector, in a computer display monitoring apparatus according to the first embodiment of the present invention.

Referring to FIG. 11, the coupler 111 or 118 of the computer display monitoring apparatus 110 includes a connector connected to the computer 100 or the monitor. The connector has a screw shaft 1101 with a slot 1102, and a solenoid 1103 attached to one side of the screw shaft 1101. If a computer user tries to detach the connector from the computer 100 or the monitor 120 at random, a solenoid shaft 1104 of the coupler 111 or 118 is caught by the slot of the screw shaft 1101 to obstruct rotation of the screw shaft 1101, thus preventing the connector from being detached from the computer 100 or the monitor 120.

In more detail, referring to FIG. 12, in the coupler 111 or 118 of the computer display monitoring apparatus 110, when the solenoid shaft 1104 is inserted into the slot 1102 formed in the screw shaft 1101 to separate the connector from the computer 100, the connector of the coupler 111 or 118 can be prevented from being detached from the computer 100. When the connector of the coupler 111 or 118 is coupled to the computer 100, the solenoid shaft 1104 moves from side to side by a force of a spring 1201. On the other hand, when the connector of the coupler 111 or 118 is decoupled from the computer 100, the solenoid shaft 1104 locked in the screw shaft 1101 is caught by the slot 1102 formed at 90 degrees in the screw shaft 1101 to obstruct rotation of the screw shaft 1101, thus preventing the connector from being detached from the computer 100. Here, the solenoid 1103 is actuated by the controller 114, and the computer display monitoring apparatus 110 can be decoupled from the computer 100 or the monitor 120 without a control signal from the controller 114 to separate the coupler from the computer 100 or the monitor 120.

When an authorized operator tries to decouple the coupler 111 or 118 from the computer 100 with the intention of repairing or the like, the operator transmits the control signal to the solenoid shaft 1104 through the controller 114. Then, the solenoid shaft 1104 moves to the right side of the spring 1201, escaping from the slot 1102 of the screw shaft 1101. At this time, the authorized operator rotates the screw shaft 1101 in a rotational direction to decouple the coupler 111 or 118 from the computer 100 or the monitor 120.

Hereinafter, a method of constructing the coupler using the stepping motor according to the second embodiment of the present invention will be described with reference to FIGS. 13 to 19.

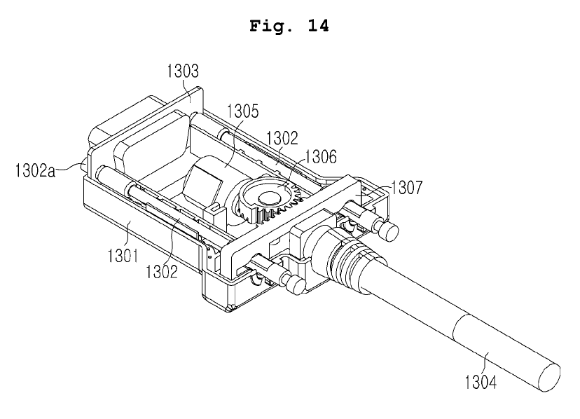

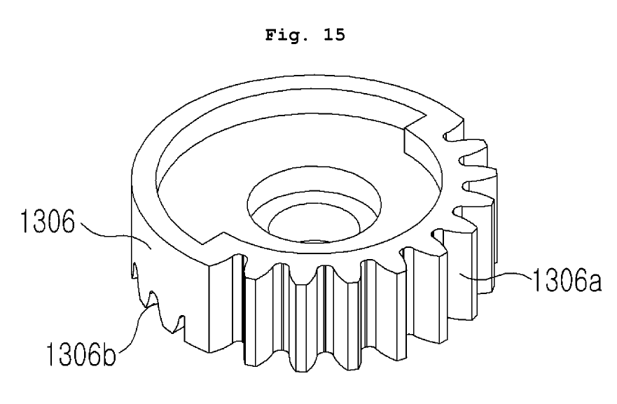

FIGS. 13 and 14 are an exploded perspective view and a structural view of the coupler in the computer display monitoring apparatus, respectively, according to the second embodiment of the present invention, and FIG. 15 is a perspective view of a gear in the coupler according to the second embodiment of the present invention.

Referring to FIGS. 13 and 14, the coupler 111 or 118 of the computer display monitoring apparatus 110 includes a connector base 1301, a connector cable 1304 inserted in one side of the connector base 1301, a connector port 1303 inserted in the other side of the connector base 1301, a motor 1305 having a rotation axis to which a gear 1305a inserted in the center of the connector base 1301 is combined, a gear unit 1306 comprising a lower gear 1306b and a side gear 1306a rotably engaging with the gear 1305a formed on the motor 1305, a rack 1307 including opposite holes 1307a and 1307a engaging with the side gear 1306a to move linearly, and a level gear 1307b formed in the rear upper middle portion, a screw shaft 1302 formed with fixing grooves 1302b and 1302b inserted in the opposite holes 1307a and 1307a of the rack 1307, and a connector cover 1308 combined with the connector base 1301.

The connector base 1301 and the connector cover 1308 combine each other to form an external appearance of the coupler 111 or 118 coupled to the computer 100 or the monitor 300 and protect internal components. At this time, the connector cable 1304 is inserted in one side of the connector base 1301 and the rack 1307 combined with the screw shaft 1302 is inserted in a slot 1301a of the connector base 1301 in the rear.

A pair of screw shafts 1302 is located in both sides of the connector base 1301. A spiral (not shown) engaging with the computer 100 or the monitor 120 is formed on the circumference of an end portion 1302a in a connection direction of the computer 100 or the monitor 300. In addition, a slot is formed in an opposite end portion 1302b to rotate the screw shaft 1302 using a driver or the like, or a grip is formed to turn the screw shaft 1302 by hand.

The connector port 1303 is located in an end portion of the connector base 1301 in the connection direction of the computer 100 or the monitor 300 and is formed with a connecting terminal in a portion 1303a connected to the computer 100 or the monitor 300. Signals such as analog video signal and so on are transmitted through the connecting terminal. In addition, in both sides of the connector port 1303 is formed a pair of holes 1303b through which the pair of screw shafts 1302 protrudes to be coupled to the computer 100 or the monitor 300.

The connector cable 1304 is located in an end portion of the connector base 1301 in a direction opposite the connection direction of the computer 100 or the monitor 300. An analog video signal inputted/outputted to the computer 100 or the monitor 300, a control signal inputted to the motor 1305, etc. are transmitted through the connector cable 1304.

The motor 1305 is located within the connector base 1301 and rotates in a clockwise or counterclockwise direction according to the control signal inputted from the controller 114. A plurality of saw teeth is formed on the protruding rotational axis gear 1305a of the motor 1305. In this embodiment, it is preferable that the motor 1305 of the coupler 111 or 118 uses a stepping motor which can be rotated by a specified degree according to the control signal from the controller 114 to facilitate an on/off control.

The gear unit 1306 comprising the lower gear 1306b and the side gear 1306a rotably engaging with the rotational axis gear 1305a of the motor 1305 is fixed in the center of the connector base 1301 by a rotational fixing pin.

As shown in FIG. 15, the gear unit 1306 is fixed in the center of the connector base 1301 so as to be rotated by 180 degrees. Thus, the side gear 1306a engages with the level gear 1307b formed in the rack 1307.

The rack 1307 includes the opposite holes 1307a and 1307a, and the level gear 1307b formed in the rear upper middle portion. The screw shafts 1302 are inserted in the opposite holes 1307a and 1307a. The fixing grooves 1302b and 1302b formed in the screw shafts 1302 are mounted on the opposite holes 1307a and 1307a.

The motor 1305 having the rotational axis gear 1305a is fixed into a fixing hole 1301b formed in the center of the connector base 1301. The connector port 1303 having the pair of holes 1303b and the portion 1303a connected to the computer 100 or the monitor 120 is inserted and fixed in the other side of the connector base 1301.

In a direction from the motor 1305 to the connector cable 1304 is formed an insertion portion 1307b having the plurality of saw teeth in a plane facing the motor 1305 and in which the protruding portion 1306b of the rack 1306 is inserted.

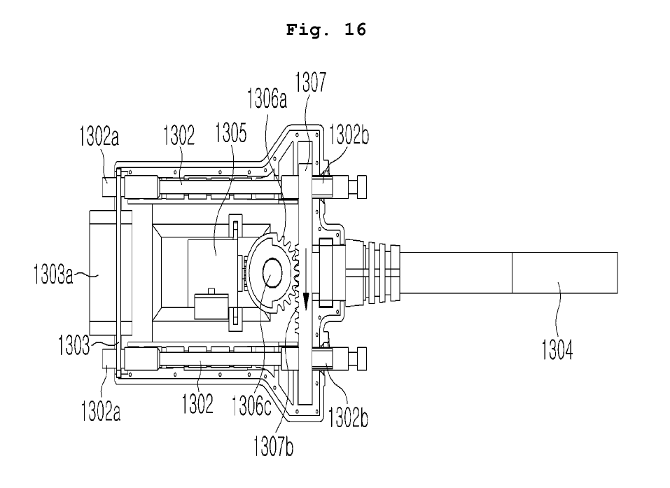

Hereinafter, the decoupled and coupled states of the coupler 111 or 118 of the computer display monitoring apparatus 110 according to the second embodiment will be described in more detail with reference to FIGS. 16 to 19.

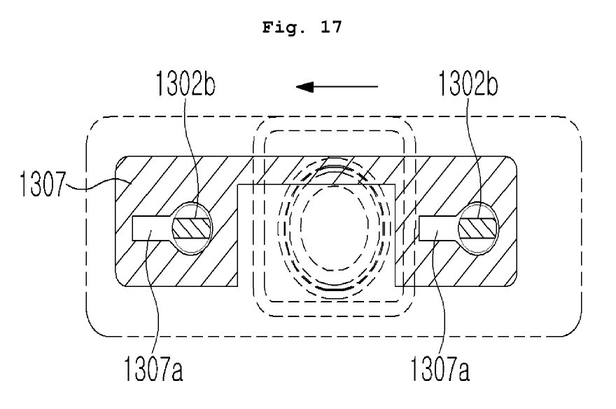

FIGS. 16 and 17 are a structural view and a front view showing a decoupled state of the second coupler 280, respectively, according to the second embodiment of the present invention.

Referring to FIG. 16, when a control signal for decoupling is inputted from the controller 114 to the motor 1305, the motor 1305 rotates in a clockwise direction when viewed from the front side of the motor 1305, and the lower gear 1306b of the gear unit 1306 engaging with the rotation axis 1305a of the motor 1305 rotates in a clockwise direction when viewed from the top side of the motor 1305. Accordingly, when the lower gear 1306b of the gear unit 1306 rotates in the clockwise direction, the rack 1307 engaging with the lower gear 1306b linearly moves downward.

Accordingly, the pair of holes 1307a formed in both sides of the rack 1307 is aligned with the slots of the end portions 1302b of the screw shafts 1302, and, as shown in FIG. 17, the slots of the end portions 1302b are exposed through the pair of holes 1307a of the rack 1307.

Accordingly, when the authorized operator tries to decouple the second coupler 118 from the computer 100 or the monitor 120 with the intention of repairing or the like, the computer display monitoring apparatus 110 can be decoupled from the computer 100 or the monitor 120 by rotating the screw shaft 1302 using a driver or the like inserted in the slots of the screw shafts 1302 exposed through the holes 1307a of the rack 1307 or turning a grip of the screw shaft 1302 by hand. In addition, by using a driver or the like inserted in the slots of the screw shafts 1302 exposed through the holes 1307a of the rack 1307, the authorized operator can couple the computer display monitoring apparatus to the computer 100 or the monitor 120.

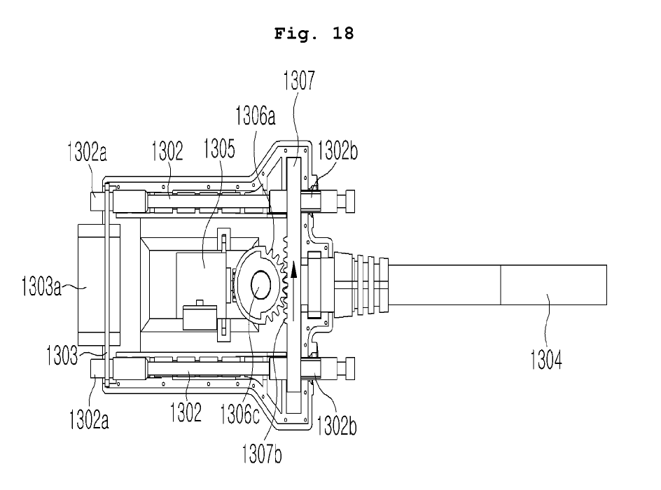

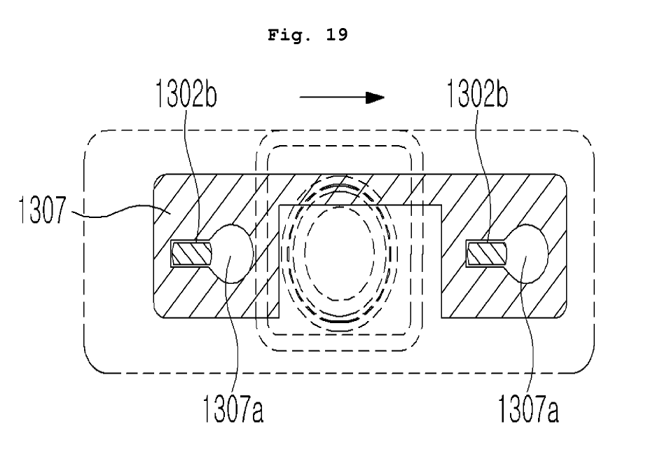

FIGS. 18 and 19 are a structural view and a front view showing a coupled state of the second coupler 118 in the computer display monitoring apparatus, respectively, according to the second embodiment of the present invention.

Referring to FIG. 18, when a control signal for coupling is inputted from the controller 114 to the motor 1305, the motor 1305 rotates in a counterclockwise direction when viewed from the front side of the motor 1305, and the lower gear 1306b of the gear unit 1306 engaging with the rotation axis 1305a of the motor 1305 rotates in a counterclockwise direction when viewed from the top side of the motor 1305. Accordingly, when the lower gear 1306b of the gear unit 1306 rotates in the counterclockwise direction, the rack 1307 engaging with the lower gear 1306b linearly moves upward.

Accordingly, the pair of holes 1307a formed in both sides of the rack 1307 is not aligned with the slots of the end portions 1302b of the screw shafts 1302, and, as shown in FIG. 19, the slots of the end portions 1302b are blocked by the rack 1307.

Accordingly, when a computer user tries to decouple the second coupler 1300 from the computer 100 or the monitor 120 at random, the computer display monitoring apparatus 110 can not be decoupled from the computer 100 or the monitor 120 since the slots of the screw shafts 1302 are blocked by the rack 1307.

As described above, the first and second embodiments may be applied to one or both of the first and second couplers 111 or 118.

Hereinafter, another method of constructing the coupler using the stepping motor according to a third embodiment of the present invention will be described with reference to FIGS. 20 to 25.

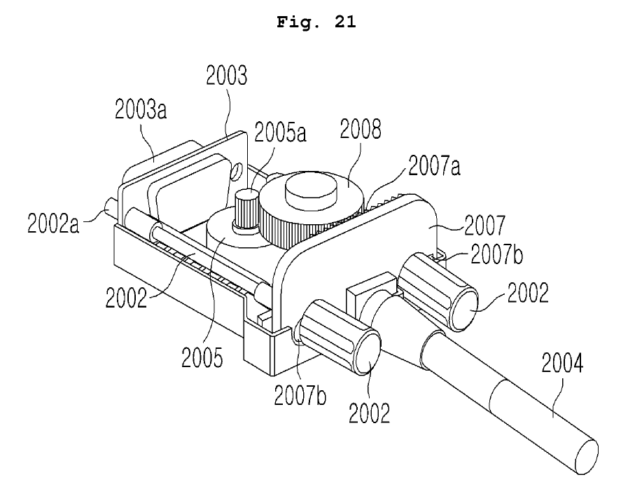

FIGS. 20 and 21 are an exploded perspective view and a structural view of the coupler in the computer display monitoring apparatus, respectively, according to the third embodiment of the present invention.

Referring to FIGS. 20 and 21, the coupler 111 or 118 of the computer display monitoring apparatus 110 includes a connector base 2001, a pair of screw shafts 2002, a connector port 2003, a connector cable 2004, a motor 2005, a rack 2007, a gear 2008, and a connector cover 2009.

The connector base 2001 and the connector cover 2009 combine each other to form an external appearance of the coupler 111 or 118 coupled to the computer 100 or the monitor 120 and protect internal components.

The pair of screw shafts 2002 is located in both sides of the connector base 2001. A spiral (not shown) engaging with the computer 100 or the monitor 120 is formed on the circumference of an end portion 2002a in a connection direction of the computer 100 or the monitor 120. In addition, rotating means by means of which an authorized operator can rotate the screw shafts 2002 is formed in an opposite end portion 2002b. In addition, the screw shafts 2002 are formed with slots 2002c connected to rotation axes of the rotating means and combined with the rack 2007 to obstruct the rotation of the screw shafts 2002.

The connector port 2003 is located in an end portion of the connector base 1301 in the connection direction of the computer 100 or the monitor 120 and is formed with a connecting terminal in a portion 2003a connected to the computer 100 or the monitor 120. Signals such as analog video signal and so on are transmitted through the connecting terminal. In addition, in both sides of the connector port 2003 is formed a pair of holes 2003b through which the pair of screw shafts 2002 protrudes to be coupled to the computer 100 or the monitor 120.

The connector cable 2004 is located in an end portion of the connector base 2001 in a direction opposite the connection direction of the computer 100 or the monitor 120. An analog video signal inputted to the computer 100 or the monitor 120, a control signal inputted to the motor 2005, etc. are transmitted through the connector cable 2004.

The motor 2005 is located within the connector base 2001 and rotates in a clockwise or counterclockwise direction according to the control signal inputted from the controller 114. A plurality of saw teeth is formed on a protruding rotational axis 2005a of the motor 2005. In the third embodiment, it is preferable that the motor 2005 of the coupler 111 or 118 uses a stepping motor which can be rotated by a specified degree according to the control signal from the controller 114 to facilitate an on/off control.

The rack 2007 is located in a direction from the motor 2005 to the connector cable 2004. The rack 2007 is formed with a plurality of saw teeth 2007a facing the motor 2005 and a pair of holes 2007b in which the screw shafts 2002 can be rotably inserted. Each of the pair of holes 2007b consists of two portions 2007b-1 and 2007b-2 having different diameters. When the screw shafts 2002 are located in the portion 2007b-1 having a larger diameter, coupling and decoupling between the coupler 111 or 118 of the computer display monitoring apparatus 110 is facilitated since there is no factor to obstruct the rotation of the screw shafts 2002. On the contrary, when the screw shafts 2002 are located in the portion 2007b-2 having a smaller diameter, the coupler 111 or 118 of the computer display monitoring apparatus 110 can not be decoupled from the computer 100 or the monitor 120 since the rack 2007 is caught by the slots 2002c of the screw shafts 2002 to obstruct the rotation of the screw shafts 2002.

The gear 2008 is located between the motor 2005 and the rack 2007. One side of saw teeth formed on the circumference of the gear 2008 engages with saw teeth formed on the rotational axis 2005a of the motor 2005, and the other side engages with saw teeth 2007a of the rack 2007. Accordingly, when the motor rotates according to a control signal from the controller 114, the gear 2008 engaging with the saw teeth of the rotational axis 2005a of the motor 2005 is rotated while moving the rack 2007 engaging with the saw teeth of the gear 2008.

Hereinafter, the decoupled and coupled states of the coupler 111 or 118 of the computer display monitoring apparatus 110 according to the third embodiment will be described in more detail.

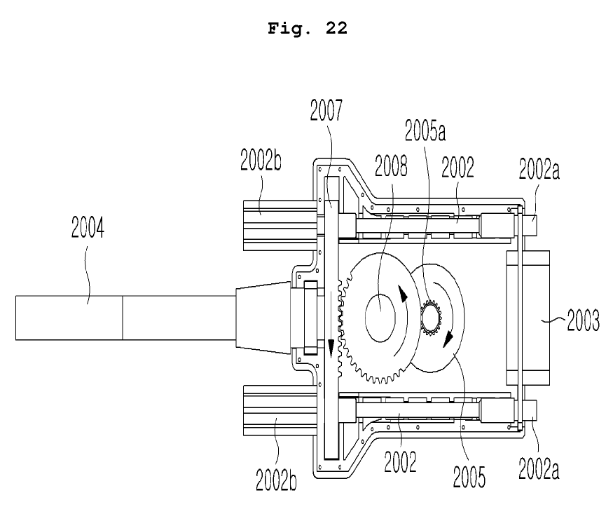

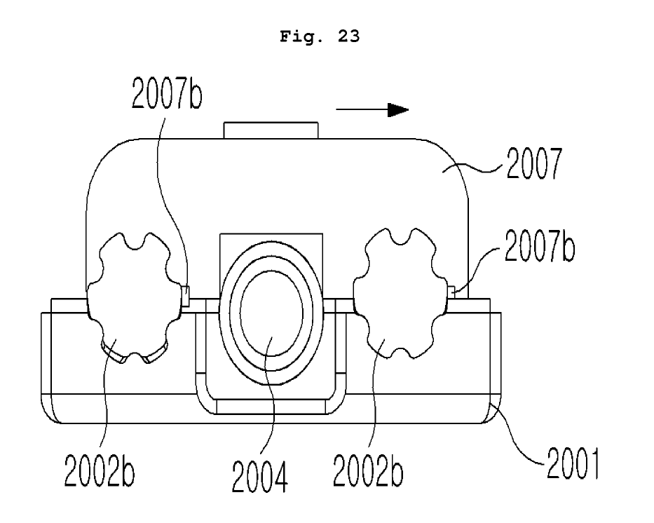

Referring to FIGS. 22 and 23, when a control signal for decoupling is inputted from the controller 114 to the motor 2005, the motor 2005 rotates in a clockwise direction, and the gear 2008 engaging with the rotation axis 2005a of the motor 2005 rotates in a counterclockwise direction. Then, the rack 2007 engaging with the saw teeth of the gear 2008 moves downward (in the right direction in FIG. 23). In this case, the pair of screw shafts 2002 moves from the portion 2007b-2 with the smaller diameter of the holes 2007b formed in both sides of the rack 2007 to the portion 2007b-1 with the larger diameter.

Accordingly, when an authorized operator tries to decouple the coupler 111 or 118 from the computer 100 or the monitor 120 with the intention of repairing or the like, the computer display monitoring apparatus 110 can be decoupled from the computer 100 or the monitor 120 by rotating the rotating means of the end portion 2002b of the screw shafts 2002. In addition, by rotating the rotating means of the end portion 2002b of the screw shafts 2002 in an opposite direction to the decoupling, the authorized operator can couple the computer display monitoring apparatus to the computer 100 or the monitor 120.

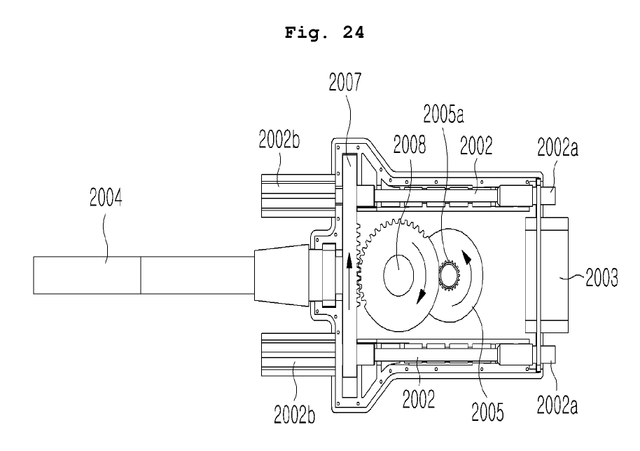

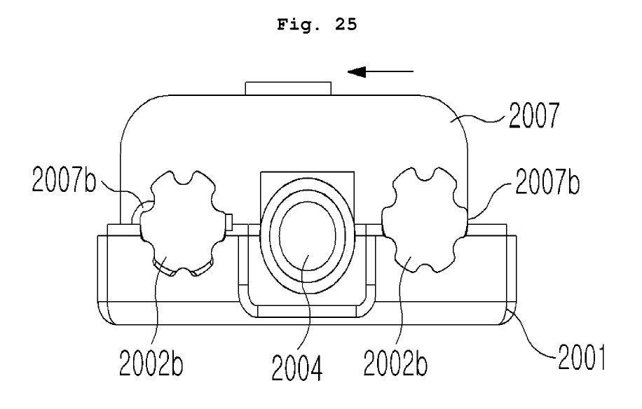

FIGS. 24 and 25 are a structural view and a front view showing a coupled state of the third coupler 111 or 118 in the computer display monitoring apparatus, respectively, according to the third embodiment of the present invention.

Referring to FIGS. 24 and 25, when a control signal for coupling is inputted from the controller 114 to the motor 2005, the motor 2005 rotates in a counterclockwise direction, and the gear 2008 engaging with the rotation axis 2005a of the motor 2005 rotates in a clockwise direction. Then, the rack 2007 engaging with the saw teeth of the gear 2008 moves upward (in the left direction in FIG. 25). In this case, the pair of screw shafts 2002 moves from the portion 2007b-1 with the larger diameter of the holes 2007b formed in both sides of the rack 2007 to the portion 2007b-2 with the smaller diameter.

Accordingly, when a computer user tries to decouple the coupler 111 or 118 from the computer 100 or the monitor 120 at random, the computer display monitoring apparatus 110 can not be decoupled from the computer 100 or the monitor 120 since the slots formed in the screw shafts 2002 engaging with the computer 100 or the monitor 120 are caught by the portion 2007b-2 with the smaller diameter of the holes 2007b formed in both sides of the rack 2007 to prevent the screw shafts 2002 from rotating.

As described above, in the computer display monitoring apparatus 110, since the first and second couplers 111 and 118 keeps a strong coupling to the computer 100 and the monitor 120, respectively, the coupling therebetween can not be released at random except decoupling by the authorized operator through the controller 114.

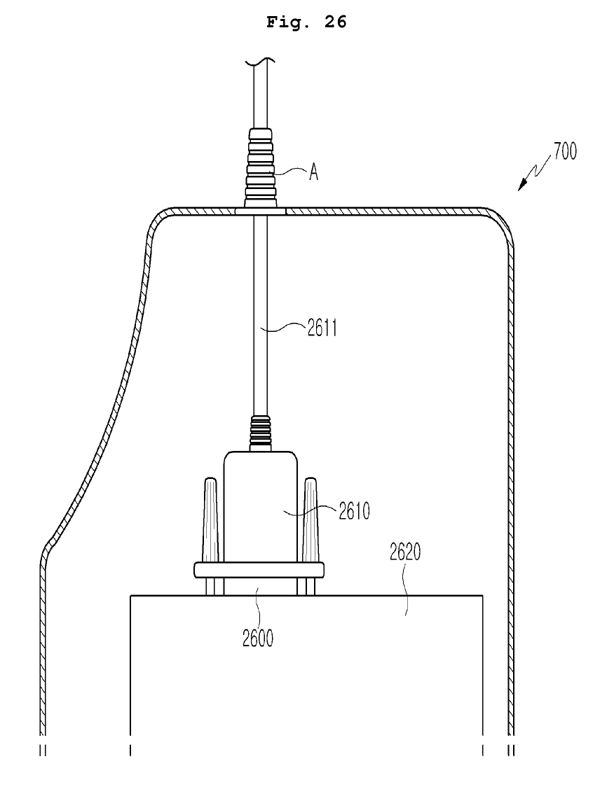

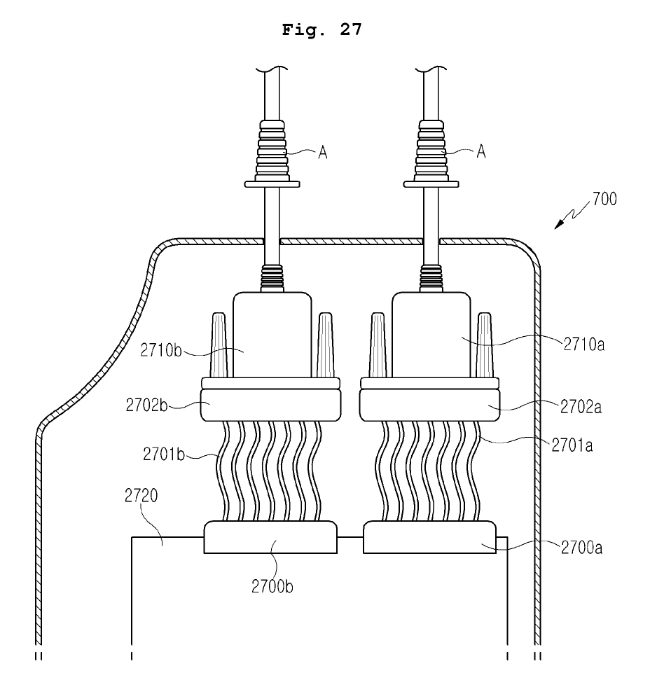

Hereinafter, a connected state of the first coupler and the second coupler in the above-described computer display monitoring apparatus will be described with reference to FIGS. 26 and 27. FIG. 26 is a structural view showing a connected state of a general computer cable, and FIG. 27 is a structural view showing a connected state in the first coupler and the second coupler in the computer display monitoring apparatus according to an exemplary embodiment of the present invention.

Referring to FIG. 26, when a general computer cable is connected in the computer display monitoring apparatus of the present invention, a casing of a computer display monitoring apparatus 700 will not shut well since a location of a noise filter A varies depending on manufacturers and product model numbers. That is, when a connecting portion 2600 of a connector 2610 connected to the computer display monitoring apparatus 700 is connected to a board 2620 inside the computer display monitoring apparatus 700, the casing of the computer display monitoring apparatus 700 may be not shut as the location of the noise filter A in a connector cable 2611 varies.

To overcome this problem, an extensible connecting cable 2701 is additionally provided between the connector 2610 and the board 2620 to allow the connector 2610 to be connected to the computer display monitoring apparatus 700 irrespective of manufacturers and product models, as shown in FIG. 27 showing an embodiment of the present invention.

FIG. 27 is a plan view showing a state where the first coupler and the second coupler are connected to the computer display monitoring apparatus.

Referring to FIG. 27, the computer display monitoring apparatus 700 may further include an extensible connecting cable 2701 to be connected to the first coupler 111 or the second coupler 118. The extensible connecting cable 2701 interconnects a connecting portion in the board 2720 located within the computer display monitoring apparatus 700 and the first coupler 111 or the second coupler 118.

As described with reference to FIG. 26, since the noise filter A of a first coupler connector 2710a or a second coupler connector 2710b connected to the connecting portion 2700 of the computer display monitoring apparatus 700 varies depending on manufacturers, product model numbers, etc., the casing of the computer display monitoring apparatus 700 will not shut or the size of the computer display monitoring apparatus 700 becomes large unnecessarily.

However, in the present invention, by using the extensible connecting cable 2701 of the computer display monitoring apparatus 700, the computer display monitoring apparatus 700 can be even thinned as long as an insertion hole having the about same diameter as a cable of the first coupler connector 2710a and the second coupler connector 2710b may be formed in the casing of the computer display monitoring apparatus 700.

As apparent from the above description, the present invention provides a computer display monitoring apparatus and method, which is capable of capturing, storing, reproducing and confirming a video used by a computer user to prevent young boys and girls from accessing harmful information in home, schools, educational institutes, etc. and to prevent some employees from accessing nonoccupational affairs.

In addition, the present invention provides a computer display monitoring apparatus and method, which is capable of being coupled to a computer and/or a monitor so tightly that computer users except an authorized operator can not decouple the apparatus from the computer and/or the monitor at their disposal, thus improving efficiency and reliability of monitoring of computer use.

Furthermore, the present invention provides a computer display monitoring apparatus, which is capable of being thinned irrespective of the size of a noise filter by using an extensible connecting cable.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display monitoring system comprising:
a computer terminal;
a monitor; and
a display monitoring apparatus provided between the computer terminal and the monitor for capturing a video signal transmitted from the computer terminal to the monitor, the display monitoring apparatus including a first coupler and a second coupler,
wherein the display monitoring apparatus receives a control signal from the computer terminal through universal serial bus (USB) communication and controls a physical coupling/decoupling between the first coupler and the computer terminal and between the second coupler and the monitor according to the received control signal,
wherein the computer terminal generates the control signal to control the display monitoring apparatus, transmits the generated control signal to the display monitoring apparatus through the USB communication, and transmits the video signal to the display monitoring apparatus via the first coupler, and
wherein the monitor receives the video signal from the display monitoring apparatus via the second coupler.

2. The display monitoring system according to claim 1, wherein, when the display monitoring apparatus is coupled to the computer terminal through the first coupler, a display monitoring apparatus control program stored in the display monitoring apparatus is automatically installed into the computer terminal through the USB communication.

3. The display monitoring system according to claim 1, wherein the computer terminal includes a remote access server for receiving a control signal to remotely control the display monitoring apparatus from a remote computer.

4. The display monitoring system according to claim 1, wherein the computer terminal includes a mobile access agent for receiving a control signal to remotely control the display monitoring apparatus from a mobile terminal.

5. The display monitoring system according to claim 1, wherein at least one of the first and second couplers includes:
a connector base forming an external appearance of the at least one coupler;
a pair of screw shafts being located in both sides of the connector base, each screw shaft having one end portion coupled to the computer terminal or the monitor and the other end portion being formed with a slot for rotation;
a connector port being located in one end portion of the connector base in a connection direction of the computer terminal or the monitor and including a connecting terminal formed in a portion connected to the computer terminal or the monitor;
a connector cable being located in the other end portion of the connector base in a direction opposite to the connection direction of the computer terminal or the monitor for transmitting an analog video signal inputted/outputted to the computer terminal or the monitor or a control signal inputted from a controller;
a motor being located in the connector base and rotating according to the control signal inputted from the controller;
a rack being located in a direction from the motor to the connector cable and having a pair of holes formed in both sides of the rack, the rack being interlocked with the motor, the pair of holes being aligned with the slots of the pair of screw shafts to expose the slots of the pair of screw shafts or to prevent the slots of the pair of screw shafts from being exposed; and
a connector cover being combined with the connector base to form an external appearance of the at least one coupler.

6. The display monitoring system according to claim 5, wherein the at least one coupler further includes a gear located between the motor and the rack and interlocked with the motor to actuate the rack.

7. The display monitoring system according to claim 1, wherein at least one of the first and second couplers includes:
a connector base forming an external appearance of the at least one coupler;
a pair of screw shafts being located in both sides of the connector base, each screw shaft having one end portion coupled to the computer terminal or the monitor and the other end portion being formed with rotating means;
a connector port being located in one end portion of the connector base in a connection direction of the computer terminal or the monitor and including a connecting terminal formed in a portion connected to the computer terminal or the monitor;
a connector cable being located in the other end portion of the connector base in a direction opposite to the connection direction of the computer terminal or the monitor for transmitting an analog video signal inputted/outputted to the computer terminal or the monitor or a control signal inputted from a controller;
a motor being located in the connector base and rotating according to the control signal inputted from the controller;
a rack being located in a direction from the motor to the connector cable and having a pair of holes formed in both sides of the rack, the rack being interlocked with the motor so that the screw shafts inserted in the pair of holes can be rotated or not; and
a connector cover being combined with the connector base to form an external appearance of the at least one coupler.

8. The display monitoring system according to claim 7, wherein the screw shafts are formed with slots in rotational axes of the rotating means and each of the holes of the rack has two integrated portions having different diameters, and
wherein the slots of the screw shafts are located in a portion having a larger diameter in each of the holes of the rack so that the screw shafts can be rotated at the time of decoupling, and the slots of the screw shafts are located in a portion having a smaller diameter in each of the holes of the rack so that the screw shafts can not be rotated at the time of coupling.

9. The display monitoring system according to claim 7, wherein the at least one coupler further includes a gear located between the motor and the rack and interlocked with the motor to actuate the rack.

10. The display monitoring system according to claim 1, wherein at least one of the first and second couplers includes a solenoid to control coupling/decoupling to/from the computer terminal or the monitor, and is coupled to and physically locked in the computer terminal or the monitor.

11. A computer display monitoring apparatus comprising:
a first coupler coupled to and physically locked in a video card of a computer for transmitting an analog video signal outputted from the video card;
an A/D (analog-to-digital) converter for converting the analog video signal inputted from the first coupler into a digital video signal;
a signal processing and storing unit for compressing and storing the digital video signal from the A/D converter at a preset time interval, and decompressing the compressed and stored digital video signal;
a D/A (digital-to-analog) converter for converting the decompressed digital video signal outputted from the signal processing and storing unit into an analog video signal;
a switch for optionally transmitting the analog video signal inputted from the video card and the analog video signal inputted from the D/A converter to the monitor;
a second coupler coupled to and physically locked in the monitor for transmitting the analog video signal inputted from the switch to the monitor; and
a controller for controlling the signal processing and storing unit, controlling the physical locking between the first coupler and the video card, and controlling the physical locking between the second coupler and the monitor.

12. The computer display monitoring apparatus according to claim 11, further comprising an extensible connecting cable connecting at least one of the first and second couplers to a connecting part located in the computer display monitoring apparatus.

13. The computer display monitoring apparatus according to claim 11, further comprising an input unit receiving access data or a control signal from the outside.

14. The computer display monitoring apparatus according to claim 11, wherein at least one of the first and second couplers includes:
a connector base forming an external appearance of the at least one coupler;
a pair of screw shafts being located in both sides of the connector base, each screw shaft having one end portion coupled to the video card or the monitor and the other end portion being formed with a slot for rotation;
a connector port being located in one end portion of the connector base in a connection direction of the video card or the monitor and including a connecting terminal formed in a portion connected to the video card or the monitor;
a connector cable being located in the other end portion of the connector base in a direction opposite to the connection direction of the video card or the monitor for transmitting an analog video signal inputted/outputted to the video card or the monitor or a control signal inputted from a controller;
a motor being located in the connector base and rotating according to the control signal inputted from the controller;
a rack being located in a direction from the motor to the connector cable and having a pair of holes formed in both sides of the rack, the rack being interlocked with the motor, the pair of holes being aligned with the slots of the pair of screw shafts to expose the slots of the pair of screw shafts or to prevent the slots of the pair of screw shafts from being exposed; and
a connector cover being combined with the connector base to form an external appearance of the at least one coupler.

15. The computer display monitoring apparatus according to claim 14, wherein the at least one coupler further includes a gear located between the motor and the rack and interlocked with the motor to actuate the rack.

16. The computer display monitoring apparatus according to claim 11, wherein at least one of the first and second couplers includes:
a connector base forming an external appearance of the at least one coupler;
a pair of screw shafts being located in both sides of the connector base, each screw shaft having one end portion coupled to the video card or the monitor and the other end portion being formed with rotating means;
a connector port being located in one end portion of the connector base in a connection direction of the video card or the monitor and including a connecting terminal formed in a portion connected to the video card or the monitor;
a connector cable being located in the other end portion of the connector base in a direction opposite to the connection direction of the video card or the monitor for transmitting an analog video signal inputted/outputted to the video card or the monitor or a control signal inputted from a controller;
a motor being located in the connector base and rotating according to the control signal inputted from the controller;
a rack being located in a direction from the motor to the connector cable and having a pair of holes formed in both sides of the rack, the rack being interlocked with the motor so that the screw shafts inserted in the pair of holes can be rotated or not; and
a connector cover being combined with the connector base to form an external appearance of the at least one coupler.

17. The computer display monitoring apparatus according to claim 16, wherein the screw shafts are formed with slots in rotational axes of the rotating means and each of the holes of the rack has two integrated portions having different diameters, and
wherein the slots of the screw shafts are located in a portion having a larger diameter in each of the holes of the rack so that the screw shafts can be rotated at the time of decoupling, and the slots of the screw shafts are located in a portion having a smaller diameter in each of the holes of the rack so that the screw shafts can not be rotated at the time of coupling.

18. The computer display monitoring apparatus according to claim 16, wherein the at least one coupler further includes a gear located between the motor and the rack and interlocked with the motor to actuate the rack.

19. The computer display monitoring apparatus according to claim 11, wherein at least one of the first and second couplers includes a solenoid to control coupling/decoupling to/from the video card or the monitor, and is coupled to and physically locked in the video card or the monitor.

20. A computer display monitoring apparatus provided between a video card of a computer and a monitor for outputting a video signal inputted from the video card to the monitor and monitoring the video signal, comprising a coupler including:
a connector base forming an external appearance of the coupler;
a pair of screw shafts being located in both sides of the connector base, each screw shaft having one end portion coupled to the video card or the monitor and the other end portion being formed with a slot for rotation;
a connector port being located in one end portion of the connector base in a connection direction of the video card or the monitor and including a connecting terminal formed in a portion connected to the video card or the monitor;
a connector cable being located in the other end portion of the connector base in a direction opposite to the connection direction of the video card or the monitor for transmitting an analog video signal inputted/outputted to the video card or the monitor or a control signal inputted from the outside;
a motor being located in the connector base and rotating according to the control signal inputted from the outside;
a rack being located in a direction from the motor to the connector cable and having a pair of holes formed in both sides of the rack, the rack being interlocked with the motor, the pair of holes being aligned with the slots of the pair of screw shafts to expose the slots of the pair of screw shafts or to prevent the slots of the pair of screw shafts from being exposed; and
a connector cover being combined with the connector base to form an external appearance of the coupler.

21. The computer display monitoring apparatus according to claim 20, wherein the coupler further includes a gear located between the motor and the rack and interlocked with the motor to actuate the rack.

22. The computer display monitoring apparatus according to claim 20, further comprising an extensible connecting cable connecting the coupler to a connecting part located in the computer display monitoring apparatus.

23. A computer display monitoring apparatus provided between a video card of a computer and a monitor for outputting a video signal inputted from the video card to the monitor and monitoring the video signal, comprising a coupler including:
a connector base forming an external appearance of the coupler;
a pair of screw shafts being located in both sides of the connector base, each screw shaft having one end portion coupled to the video card or the monitor and the other end portion being formed with rotating means;
a connector port being located in one end portion of the connector base in a connection direction of the video card or the monitor and including a connecting terminal formed in a portion connected to the video card or the monitor;
a connector cable being located in the other end portion of the connector base in a direction opposite to the connection direction of the video card or the monitor for transmitting an analog video signal inputted/outputted to the video card or the monitor or a control signal inputted from a controller;
a motor being located in the connector base and rotating according to the control signal inputted from the controller;
a rack being located in a direction from the motor to the connector cable and having a pair of holes formed in both sides of the rack, the rack being interlocked with the motor so that the screw shafts inserted in the pair of holes can be rotated or not; and
a connector cover being combined with the connector base to form an external appearance of the coupler.

24. The computer display monitoring apparatus according to claim 23, wherein the screw shafts are formed with slots in rotational axes of the rotating means and each of the holes of the rack has two integrated portions having different diameters, and
wherein the slots of the screw shafts are located in a portion having a larger diameter in each of the holes of the rack so that the screw shafts can be rotated at the time of decoupling, and the slots of the screw shafts are located in a portion having a smaller diameter in each of the holes of the rack so that the screw shafts can not be rotated at the time of coupling.

25. The computer display monitoring apparatus according to claim 23, wherein the coupler further includes a gear located between the motor and the rack and interlocked with the motor to actuate the rack.

26. The computer display monitoring apparatus according to claim 23, further comprising an extensible connecting cable connecting the coupler to a connecting part located in the computer display monitoring apparatus.

27. A computer display monitoring method comprising the steps of:
(A) physically locking one of a first coupler and a second coupler to be coupled to a video card and a monitor, respectively, in the video card or the monitor as a rack prevents a pair of screw shafts from rotating, the rack being interlocked with a motor rotating according to a control signal inputted from a controller;
(B) converting a first analog video signal inputted from the video card through the first coupler into a digital video signal;
(C) compressing and storing the digital video signal at a preset time interval;
(D) decompressing the stored digital video signal and converting the decompressed digital video signal into a second analog video signal to be reproduced in the monitor; and
(E) transmitting the second analog video signal to the monitor through the second coupler.

28. The computer display monitoring method according to claim 27, wherein the step (A) further includes (A-1) physically locking the other of the first coupler and the second coupler to be coupled to an external device including the video card and the monitor in the external device by using a solenoid to control coupling/decoupling to/from the external device.

29. The computer display monitoring method according to claim 27, wherein the step (B) further includes (B-1) transmitting the first analog video signal inputted from the video card through the first coupler to the monitor.

30. The computer display monitoring method according to claim 27, wherein the step (D) further includes (D-1) preventing the first analog video signal inputted from the video card through the first coupler from being transmitted to the monitor.
